(19) United States
(12) Patent Application Publication
(10) Pub. No.: US 2026/0134582 A1
(43) Pub. Date: May 14, 2026

(54) DECODER, ENCODER, SYSTEM, DATA STREAM, METHOD AND COMPUTER PROGRAM FOR NN RENDERING IN SCENES BASED ON AN ANCHORING INFORMATION

(71) Applicant: Fraunhofer-Gesellschaft zur Förderung der angewandten Forschung e.V., München (DE)

(72) Inventors: Yago SÁNCHEZ DE LA FUENTE, Berlin (DE); Sergio TEJEDA PASTOR, Berlin (DE); Robert SKUPIN, Berlin (DE); Cornelius HELLGE, Berlin (DE); Thomas SCHIERL, Berlin (DE); Thomas WIEGAND, Berlin (DE)

(21) Appl. No.: 19/444,476

(22) Filed: Jan. 9, 2026

Related U.S. Application Data
(63) Continuation of application No. PCT/EP2024/069364, filed on Jul. 9, 2024.

(30) Foreign Application Priority Data
Jul. 10, 2023 (EP) 23184551.2

(51) Int. Cl. G06T 9/00; G06T 11/00

(52) U.S. Cl. CPC G06T 9/002; G06T 11/00

(57) ABSTRACT

Embodiments according to the invention have a decoder, wherein the decoder is configured to decode, from a data stream, a scene description information for a rendering of a scene, which comprises a neural network information for a neural rendering of an object of the scene, and an anchoring information, which indicates a position, of the object within the scene.

Furthermore, embodiments address a rendering of additional objects in the scene, and respective encoders, systems, data streams, methods and computer programs are disclosed.

### CROSS-REFERENCE TO RELATED APPLICATIONS

This application is a continuation of copending International Application No. PCT/EP 2024/069364, filed Jul. 9, 2024, which is incorporated herein by reference in its entirety, and additionally claims priority from European Application No. 23184551.2, filed Jul. 10, 2023, which is also incorporated herein by reference in its entirety.

### INTRODUCTORY REMARKS

Embodiments according to the invention are related to decoders, encoders, systems, data streams, methods and computer programs for neural network, NN, rendering in scenes based on an anchoring information.

Embodiments according to the invention comprise a concept for an integration of Neural Network based Rendering in glTF.

In the following, different inventive embodiments and aspects will be described regarding the usage of Neural Networks (NNs) for rendering objects within a scene.

### TECHNICAL FIELD

The invention is within the technical field of rendering of a scene or objects therein, e.g., volumetric video, using NNs.

Embodiments of the invention refer to data streams having data encoded therein in a scene description language that steers the rendering performed by the NN and deals with co-rendering of different modules, e.g., neural rendering and regular GPU 3D rendering, e.g., using regular meshes, point-clouds, etc. Further embodiments refer to devices for generating such data streams, devices for evaluating such data streams, methods of generating such data streams, and methods of evaluating such data streams. Further embodiments refer to a computer program product.

### BACKGROUND OF THE INVENTION

It is envisioned that in a near future streaming of new applications in the area of Virtual Reality (VR), Augmented Reality (AR) and Mixed Reality (MR) will become a popular service that can be consumed for several applications. The expectations of such applications are based on the fact that the content is represented in high-quality (e.g. photorealistic) and that it may give the impression that it is real which may lead to an immersive experience.

Such applications can correspond to static or dynamic objects being inserted into a scene. One example thereof can be volumetric video that represents 3-D content, which can comprise or consist of real objects captured by camera rigs. In the past, extensive work has been carried out with 3-D computer graphics based heavily on Computer-Generated Imagery (CGI). The images may be dynamic or static and are used in video games or scenes and special effects in films and television.

With the late advances in volumetric video capturing and emerging HMD devices, VR/AR/MR have raised a lot of attention. Services enabled thereby are very diverse but comprise or consist mainly of objects being added on-the-fly to a given real scene, generating thus a mixed reality, or even added to a virtual scene if VR is considered. In order to achieve a high-quality, and an immersive experience, the 3-D volumetric objects may, for example, need to be transmitted at high-fidelity, which could demand a very high bitrate.

Therefore, it is desired to get a concept for a rendering of scenes, which makes a better compromise between a visual quality of the scene, e.g. for achieving a photorealistic quality, a manipulability of the scene, e.g. with regard to virtual reality, augmented reality and/or mixed reality applications, and a computational effort and transmission resources required for the processing and transmission of respective scene information.

In this document, some basic concepts used for 3D content transmission formats, animations are described. It is followed by an exploration of different approaches to enable more photo-realistic objects to be rendered into a scene in a more efficient manner.

### SUMMARY

An embodiment may have a decoder, wherein the decoder is configured to decode, from a data stream, a scene description information for a rendering of a scene, which has: a neural network information for a neural rendering of an object of the scene, and an anchoring information, which indicates a position of the object within the scene.

Another embodiment may have a decoder, wherein the decoder is configured to decode, from a data stream, a scene description information for a rendering of a scene, which has: a rendering information for a rendering of a first object of the scene, the first object having a first position within the scene, a neural network information for a neural rendering of a second object of the scene, and an anchoring information, which indicates a second position of the second object within the scene.

Another embodiment may have a system comprising a decoder configured to decode, from a data stream, a scene description information for a rendering of a scene, which has: a neural network information for a neural rendering of an object of the scene, and an anchoring information, which indicates a position of the object within the scene, and a preprocessing unit; wherein the neural network information comprises a neural input information indicating a neural input; wherein the decoder is configured to provide the neural input information to the preprocessing unit, which is configured to obtain the neural input, which is indicated by the neural input information, and to provide a version of said neural input via one or more buffers to a renderer for performing the inference for the neural rendering based on the version of the neural input; and wherein the decoder is configured to provide the scene description information, at least partially, to the renderer.

Another embodiment may have a system comprising a decoder configured to decode, from a data stream, a scene description information for a rendering of a scene, which has: a neural network information for a neural rendering of an object of the scene, and an anchoring information, which indicates a position of the object within the scene, and a preprocessing unit; wherein the decoder is configured to provide the neural network information to the preprocessing unit; wherein the preprocessing unit is configured to perform an inference for the neural rendering based on the neural network information and a neural input.

Another embodiment may have an encoder, wherein the encoder is configured to encode, into a data stream, a scene description information for a rendering of a scene, which has a rendering information for a rendering of a first object of a scene, the first object having a first position within the scene, a neural network information for a neural rendering of a second object of the scene, and an anchoring information, which indicates a second position of the second object within the scene.

According to another embodiment, a method may have the step of: decoding, from a data stream, a scene description information for a rendering of a scene, which has a rendering information for a rendering of a first object of a scene, the first object having a first position within the scene, a neural network information for a neural rendering of a second object of the scene, and an anchoring information, which indicates a second position of the second object within the scene.

According to another embodiment, a method may have the step of: encoding, into a data stream, a scene description information for a rendering of a scene, which has a rendering information for a rendering of a first object of a scene, the first object having a first position within the scene, a neural network information for a neural rendering of a second object of the scene, and an anchoring information, which indicates a second position of the second object within the scene.

Still another embodiment may have a computer program for performing the above methods according to the invention when the computer program runs on a computer.

According to another embodiment, a data stream may have: a scene description information for a rendering of a scene, which has a rendering information for a rendering of a first object of a scene, the first object having a first position within the scene, a neural network information for a neural rendering of a second object of the scene, and an anchoring information, which indicates a second position of the second object within the scene.

Another embodiment may have an encoder, wherein the encoder is configured to encode, into a data stream, a scene description information for a rendering of a scene, which has a neural network information for a neural rendering of an object of the scene, and an anchoring information, which indicates a position of the object within the scene.

According to another embodiment, a method may have the step of: decoding, from a data stream, a scene description information for a rendering of a scene, which has a neural network information for a neural rendering of an object of the scene, and an anchoring information, which indicates a position of the object within the scene.

According to another embodiment, a method may have the step of: encoding, into a data stream, a scene description information for a rendering of a scene, which has a neural network information for a neural rendering of an object of the scene, and an anchoring information, which indicates a position of the object within the scene.

According to another embodiment, a data stream may have: a scene description information for a rendering of a scene, which has a neural network information for a neural rendering of an object of the scene, and an anchoring information, which indicates a position of the object within the scene.

Embodiments according to the invention comprise a decoder, which is configured to decode, from a data stream, a scene description information for a rendering of a scene, which comprises: a neural network information for a neural rendering of an object of the scene, and an anchoring information, which indicates a position of the object within the scene.

The inventors recognized that based on the anchoring information, a neurally rendered object may be positioned within a scene, so as to allow, for example for virtual reality, augmented realty and/or mixed reality applications, an efficient manipulation of the object, using neural rendering techniques, for example, at an arbitrary position within the scene. For example, in contrast to conventional neural rendering approaches, the anchoring information may be taken into account for the rendering, so as to provide a photorealistic appearance of the object in the scene, e.g. with regard to environmental influences, e.g. lighting, of a surrounding of the object in the scene. Hence, embodiments may comprise a rendering of a single object into a scene.

As an example, the anchoring information may comprise a translation information, a tilt information and/or a rotation information, allowing positioning the object in the scene. In particular, the inventors recognized that the provision of neural network information and anchoring information, hence information for performing the rendering itself and position information, within a same data stream allows a joint processing so as to take the position information into account at a rendering stage, e.g. in contrast to conventional approaches.

It is to be noted that embodiments according to the invention may comprise corresponding methods for decoding, corresponding encoders, corresponding methods for encoding and/or corresponding data streams. Respective encoders, methods and/or data streams may be supplemented by any feature, functionality and/or detail as disclosed with regard to a respective decoder, both individually or taken in combination.

Embodiments according to the invention comprise a decoder, wherein the decoder is configured to decode, from a data stream, a scene description information for a rendering of a scene (e.g. a glTF file; e.g. in a scene description language format; e.g. in the form of a scene description having a hierarchical order; e.g. representing a plurality of scene elements, e.g. in the form of nodes), which comprises a rendering information (e.g. a mesh representation, e.g. a point cloud representation) for a rendering of a first object of the scene, the first object having a first position, e.g. absolute position; e.g. relative position; e.g. relative position towards a viewer, within the scene, a neural network information (e.g. about NN parameters; e.g. about a NN topology; e.g. a reference to NN parameters and/or a NN topology; e.g. an uri; e.g. an URL) for a neural rendering of a second object of the scene, and an anchoring information (e.g. indicating a position and/or relative position of the second object in the scene and/or towards a viewpoint), which indicates a second position, e.g. absolute position; e.g. relative position; e.g. relative position towards a viewer, of the second object within the scene.

The inventors recognized that using a neural rendering of specific objects within a scene may allow achieving a better compromise between a quality of a scene, degrees of freedom for scene manipulation and computational and/or signaling efforts.

Furthermore, the inventors recognized that the provision of the anchoring information may even allow performing a mixed rendering of such a scene. As an example, a conventionally rendered scene, e.g. in the sense that mesh and/or point cloud rendering is performed, may be supplemented in that one or more objects of the scene, at positions as identified by the anchoring information, may be rendered neurally, hence, for example, based on a result of an inference of a neural network.

In particular, this may allow performing a hybrid form of rendering, wherein certain objects are, as an example, rendered in photorealistic quality, even whilst being manipulated in a time dependent manner, based on the neural rendering, and wherein, on the other hand, for example less computationally expensive conventional rendering may be performed for a rest of the scene.

However, it is to be noted that the first object may optionally be as well rendered neurally, e.g. so that the rendering information is as well a neural rendering information, e.g. indicating parameters, such as neural network weights, for performing an inference.

On the other hand, the rendering information for the first object may optionally comprise an information about a mesh and/or about a point cloud of a representation of the first object, for a non-neural rendering or rendition of the first object.

According to an embodiment of the invention, the neural network information optionally comprises an information about neural network parameters and/or an information about a neural network topology for the neural rendering. Furthermore, optionally, the neural network information may comprise a referencing information (e.g. an uri; e.g. an URL, e.g. for downloading a binary executable comprising an information about neural network parameters) and/or an information about a neural network topology.

Hence, the neural network information may comprise the neural network used for the rendering of the second object, namely an information about its topology and respective weights, so that an inference can be performed, and/or the neural network information may comprise at least an information on where to obtain such an information. As an example, a form of media access function (e.g. of a preprocessing unit, e.g. an MAF, e.g. media access function) may manage the retrieval of such a neural network information based on the referencing information.

Furthermore, embodiments according to the invention comprise a system comprising a decoder (e.g. according to any of the embodiments as disclosed herein) and a preprocessing unit, e.g. MAF. Furthermore, the neural network information may comprise a neural input information indicating a neural input and the decoder may be configured to provide the neural input information, e.g. a decoded version thereof, to the preprocessing unit, which may be configured to obtain (e.g. via Media Requests; e.g. via Media Access) the neural input, which is indicated by the neural input information, and to provide a version of said neural input via one or more buffers to a renderer, e.g. a Presentation Engine, for performing the inference for the neural rendering based on the version (e.g. a version of the data suitable for a storing in the buffer) of the neural input. In addition, the decoder may be configured to provide (e.g. via a Buffer Management, e.g. via the renderer; e.g. via one or more Buffer APIs; e.g. via a MAF API) the scene description information, at least partially (e.g. a rendering specific part thereof, i.e. for example not the neural input information, an information of which may be provided in the form of the neural input via the buffer, but, for example, not directly from decoder to renderer), to the renderer.

As an example, the inference for the neural rendering may hence be performed in or respectively by the renderer. The information about the neural network, which is used in order to perform the inference, may be a portion of the at least partially provided scene description information. Hence, as explained before, this way, an information about neural network weights and/or a topology of the neural network may be provided to the renderer. Optionally however, the renderer may obtain only a reference information (e.g. a referencing information) and may request said weights and/or topology information from a different source, e.g. via a media access function, MAF, (and optionally respective APIs).

Accordingly, the preprocessing unit, e.g. such an MAF, may be configured to receive the referencing information about the neural network from the decoder (or renderer) and may optionally be configured to obtain the neural network weights and/or a topology information (e.g. via a media access; for example using requests) and to provide the same to the renderer, for example, but not necessarily via the one or more buffers. Hence, it is to be noted that the neural network information may be provided directly from the decoder to the renderer.

Furthermore, as explained before, the renderer may optionally be provided with the neural input as well as, optionally, a rendering input for performing a mixed rendering of the scene. Based on the neural input (e.g. via the one or more buffers) and optionally the information about the neural network parameters and/or network topology, e.g. as part of the neural network information, an inference may performed for the rendition of the second object of the scene and based on the rendering input a conventional rendition, e.g. a non-neural rendering, for example, a mesh and/or point cloud rendering, of the first object of the scene may be performed.

Such a mixed rendering may be performed based on the anchoring information, e.g. as contained in a portion of the scene description information that is provided to the renderer, allowing to combine the different rendering techniques.

In particular, an input for the neural rendering in the renderer may be a mesh, a 2D video/audio and/or a point cloud. Hence, the neural rendering may comprise a manipulation, e.g. on the fly, of such inputs.

An embodiment of the invention comprises a system comprising a decoder (e.g. according to any of the embodiments herein) and a preprocessing unit, e.g. MAF. The decoder may be configured to provide the neural network information to the preprocessing unit and the preprocessing unit may be configured to perform an inference for the neural rendering based on the neural network information and a neural input. As an optional feature, the neural network information comprises a neural input information indicating the neural input based on which the inference is to be performed for the neural rendering.

Hence, the inference for the neural rendering may be performed in the preprocessing unit, for example, so that a respective renderer, which may be provided with a result of the inference, e.g. in the form of a mesh, a 2D video/audio/image and/or a point cloud may not have to be configured for performing an inference of a NN. The renderer may hence be agnostic about the neural rendering. In other words, the preprocessing unit may exploit the advantages of neural rendering for providing an information about the second object in the scene in a certain output format, wherein this output format may be a format in which the rendering input is provided for the rendering of the first object. This may allow for a same or at least similar rendition of the first and second object in the renderer. The rendition of the second object by the renderer may, within this disclosure, still be referenced as a neural rendering, since the rendering, for example although performed using a mesh and/or point cloud, may be based on the inference of the preprocessing unit based on which the mesh and/or point cloud is obtained.

Furthermore, embodiments comprise an encoder, wherein the encoder is configured to encode, into a data stream, a scene description information for a rendering of a scene (e.g. glTF file; e.g. in a scene description language format; e.g. in the form of a scene description having a hierarchical order; e.g. representing a plurality of nodes), which comprises a rendering information, e.g. a mesh representation, e.g. a point cloud representation, for a rendering of a first object of a scene, the first object having a first position (e.g. absolute position; e.g. relative position; e.g. relative position towards a viewer) within the scene, a neural network information (e.g. about NN parameters; e.g. about a NN topology; e.g. a reference to NN parameters and/or a NN topology; e.g. an uri; e.g. an URL) for a neural rendering of a second object of the scene, and an anchoring information (e.g. indicating a position and/or relative position of the second object in the scene and/or towards a viewpoint), which indicates a second position (e.g. absolute position; e.g. relative position; e.g. relative position towards a viewer) of the second object within the scene.

The encoder as described above may be based on the same considerations as the above-described decoder. The encoder can, by the way, be completed with all features and functionalities, e.g. in a corresponding manner (e.g. encoding->decoding and vice versa), which are also described with regard to the decoder.

Furthermore, embodiments comprise a method comprising: decoding, from a data stream, a scene description information for a rendering of a scene (e.g. glTF file; e.g. in a scene description language format; e.g. in the form of a scene description having a hierarchical order; e.g. representing a plurality of nodes), which comprises a rendering information, e.g. a mesh representation, e.g. a point cloud representation, for a rendering of a first object of a scene, the first object having a first position, e.g. absolute position; e.g. relative position; e.g. relative position towards a viewer, within the scene, a neural network information (e.g. about NN parameters; e.g. about a NN topology; e.g. a reference to NN parameters and/or a NN topology; e.g. an uri; e.g. an URL) for a neural rendering of a second object of the scene, and an anchoring information (e.g. indicating a position and/or relative position of the second object in the scene and/or towards a viewpoint), which indicates a second position (e.g. absolute position; e.g. relative position; e.g. relative position towards a viewer) of the second object within the scene.

The method as described above may be based on the same considerations as the above-described decoder. The method can, by the way, be completed with all features and functionalities, which are also described with regard to the decoder.

Furthermore, embodiments comprise a method comprising: encoding, into a data stream, a scene description information for a rendering of a scene (e.g. glTF file; e.g. in a scene description language format; e.g. in the form of a scene description having a hierarchical order; e.g. representing a plurality of nodes), which comprises a rendering information, e.g. a mesh representation, e.g. a point cloud representation, for a rendering of a first object of a scene, the first object having a first position (e.g. absolute position; e.g. relative position; e.g. relative position towards a viewer) within the scene, a neural network information (e.g. about NN parameters; e.g. about a NN topology; e.g. a reference to NN parameters and/or a NN topology; e.g. an uri; e.g. an URL) for a neural rendering of a second object of the scene, and an anchoring information (e.g. indicating a position and/or relative position of the second object in the scene and/or towards a viewpoint), which indicates a second position (e.g. absolute position; e.g. relative position; e.g. relative position towards a viewer) of the second object within the scene.

The method as described above may be based on the same considerations as the above-described encoder. The method can, by the way, be completed with all features and functionalities, which are also described with regard to the encoder.

Furthermore, embodiments comprise a computer program for performing a method according to an embodiment as disclosed herein, when the computer program runs on a computer.

Furthermore, embodiments comprise a data stream comprising: a scene description information for a rendering of a scene (e.g. glTF file; e.g. in a scene description language format; e.g. in the form of a scene description having a hierarchical order; e.g. representing a plurality of nodes), which comprises a rendering information, e.g. a mesh representation, e.g. a point cloud representation, for a rendering of a first object of a scene, the first object having a first position (e.g. absolute position; e.g. relative position; e.g. relative position towards a viewer) within the scene, a neural network information (e.g. about NN parameters; e.g. about a NN topology; e.g. a reference to NN parameters and/or a NN topology; e.g. an uri; e.g. an URL) for a neural rendering of a second object of the scene, and an anchoring information (e.g. indicating a position and/or relative position of the second object in the scene and/or towards a viewpoint), which indicates a second position (e.g. absolute position; e.g. relative position; e.g. relative position towards a viewer) of the second object within the scene.

The data stream as described above may be based on the same considerations as the above-described decoder and/or encoder as well as corresponding methods. The data stream can, by the way, be completed with all features and functionalities (e.g. in a corresponding manner), which are also described with regard to the decoder and/or encoder.

### BRIEF DESCRIPTION OF THE DRAWINGS

The drawings are not necessarily to scale, emphasis instead generally being placed upon illustrating the principles of the invention. In the following description, various embodiments of the invention are described with reference to the following drawings, in which:

FIG. 1 shows a schematic view of an example of a glTF integration, according to embodiments;

FIG. 2 shows a schematic data structure in glTF, according to embodiments;

FIG. 3 shows a schematic block diagram of MPEG extensions in glTF according to embodiments;

FIG. 4 shows a schematic example of a basic architecture of glTF, according to embodiments;

FIG. 5 a), b) show schematic views of decoders according to embodiments of the invention;

FIG. 6 shows a schematic view of a system for performing an inference for the neural rendering in a renderer, according to embodiments;

FIG. 7 shows a schematic view of a system for performing an inference for the neural rendering in a preprocessing unit, according to embodiment;

FIG. 8 a) to f) show examples of respective inputs for a neural network and respective outputs, according to embodiments;

FIG. 9 shows a schematic view of an example of a NN taking as input a points in the space (controlled by renderer) and outputting, an opacity and color dependent on viewing direction, according to embodiments;

FIG. 10 shows a schematic example of a basic principle of NeRF, according to embodiments;

FIG. 11 shows a schematic example of a description of the inputs and outputs of the NN in NeRF, according to embodiments;

FIG. 12 shows a first example (e.g. Example 1) of a code for a scene description according to embodiments;

FIG. 13 shows a second example (e.g. Example 2) of a code for a scene description according to embodiments;

FIG. 14 shows a third example (e.g. Example 3) of a code for a scene description according to embodiments;

FIG. 15 shows a fourth example (e.g. Example 4) of a code for a scene description according to embodiments;

FIG. 16 shows a schematic view of a use of a NN to generate mesh/texture based objects, according to embodiments;

FIG. 17 shows a fifth example (e.g. Example 5) of a code for a scene description according to embodiments;

FIG. 18 shows a sixth example (e.g. Example 6) of a code for a scene description according to embodiments;

FIG. 19 shows a schematic view of an example for the use of NNs to modify existing objects of the scene; and

FIG. 20 a), b) show schematic views of encoders according to embodiments of the invention.

### DETAILED DESCRIPTION OF THE INVENTION

Equal or equivalent elements or elements with equal or equivalent functionality are denoted in the following description by equal or equivalent (e.g. 401′-601′-701′; e.g. 400-500a-500b) reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

For a better understanding of the invention, next, reference is made to basic concepts according to at least some embodiments of the invention.

### Basic Concepts

Compression of 3D content has drawn some attention lately. An example thereof is Draco, an open source library for compressing and decompressing 3D geometric meshes and point clouds. In addition, there is currently some standardization work ongoing in MPEG to specify solutions for point cloud compression and mesh compression. When such solutions are widely deployed and achieve a reasonable compression efficiency and complexity, transmission of dynamic 3D geometric objects, i.e. a sequence of a moving 3D geometric object will be feasible.

Although mentioned approaches (e.g. as discussed in sections technical field and/or background) work and might be feasible, in some cases there are several issues when trying to stream captured 3D content.
1. It is not simple to generate a point cloud or mesh of high quality (i.e. photorealistic quality) from captured content, which may be captured only through several 2D representations (e.g. static images or the continuous stream of pictures from a video with a moving camera), or even be accompanied with some depth information.
2. Compression and decompression of dynamic meshes might be complicated and not yet efficient enough to enable transport of live processing.
3. Rigging such meshes in order to allow meshes to be animated or to interact with them and modify them (e.g., change posture, object form, etc.) is not straight forward and may require manual processing of meshes which is very expensive and not viable in live scenarios.
4. Even point cloud animation might not be possible or doable in real time.

Some of the problems mentioned above, have been solved and mostly overcome in the past, particularly applied to CGI content. However, when it comes to applying that to real-world captured content, it is a tedious task and does not often result in photo-realistic quality.

As an alternative to using well defined points in space (point clouds) or e.g., triangles with an additional texture (meshes) to represent objects, as any GPU can handle, recently, NNs based schemes have been used to render objects [ref1][ref2].

The methods that have been shown as for now show a big potential on this area. However, to some extent, the methods are at the proof of concept stage and they show that rendering such objects is feasible, but they miss many aspects when it comes to being rendered in the context of a scene. As for now, it is not clear how to create and play a mixed scene where some parts are rendered using traditional techniques, e.g., point clouds or polygon meshes, and some other content is represented/rendered by a NN-based scheme as mentioned above. On top of this, the possibility of using NNs to modify already rendered elements has not been integrated into such a system yet. Several aspects are discussed in the following sections to solve many of the issues of such mixed scenes.

As for the following embodiments related to these aspects, they are based on the concept of scene description.

Generally, the 3D content is comprised or contained under a scene structure that specifies how it should be rendered. This is also called a scene description. Sophisticated 3D scenes can be created with authoring tools. These tools allow one to edit the structure of the scene, the light setup, cameras, animations, and, of course, the 3D geometry of the objects that appear in the scene. Applications store this information in their own, custom file formats for storage and export purposes. For example, Blender stores the scenes in .blend files, LightWave3D uses the .lws file format, 3ds Max uses the .max file format, and Maya uses .ma files.

An important part that is beneficial or even required for the applications described in the instruction is a scene description. A scene description language may, for example, be a language used to describe a scene to a 3D renderer, i.e. how objects that collectively form a scene are composed (e.g. 3D/2D geometry, form, textures, animations) and/or arranged with respect to each other. There are several scene description languages.

Khronos started the GL Transmission Format (glTF) to bring a unified solution to fragmented practice of imports and exports for 3D scenes. The solution includes:
A scene structure described with JSON, which is very compact and can easily be parsed.
The 3D data of the objects are stored in a form that can be directly used by the common graphics APIs such as OpenGL, WebGL, etc., so there may, for example, be no overhead for decoding or pre-processing the 3D data.

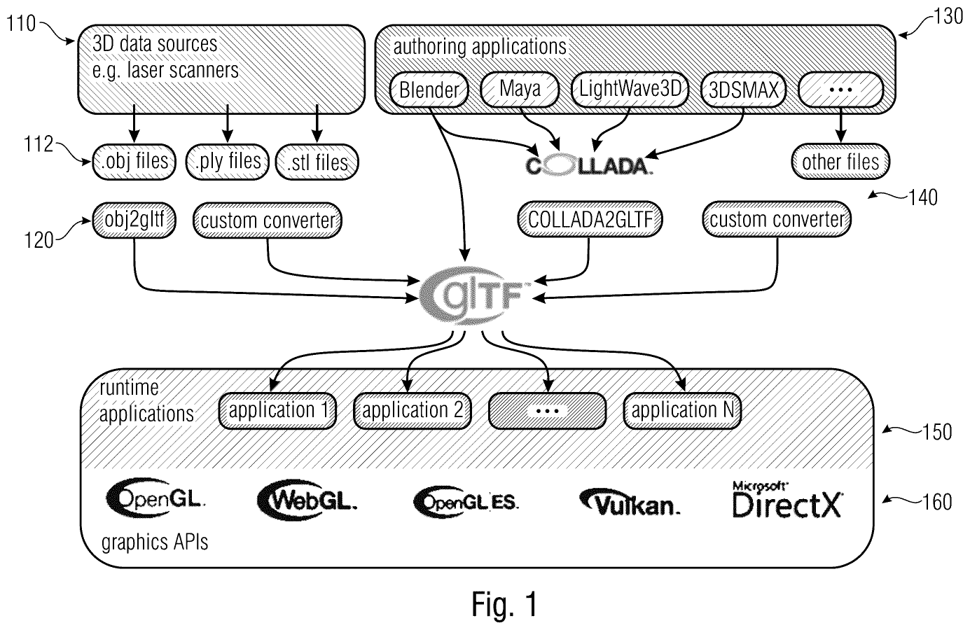

The description herein may be mainly focusing on glTF but this should be understood as an example, as the embodiments described herein could be similarly integrated in any other scene description format, for example as listed in the examples above. See also FIG. 1:
FIG. 1 shows a schematic view of an example of a glTF integration, according to embodiments. FIG. 1 shows 3D data sources 110 (e.g. laser scanners) which provide, as an example, 3D data 112 in respective data formats, e.g. as shown obj. files, .ply files and/or .stl files. Using a respective conversion functionality 120, e.g. obj2gltf, e.g. a custom converter, respective 3D data 112 can be converted to a GL Transmission Format file.

Furthermore in FIG. 1 authoring applications, e.g. authoring tools 130 are shown (with examples, such as Blender, Maya, LightWave3D, 3DSMAX) which may allow manipulating a respective scene (e.g. to edit the structure of the scene, the light setup, cameras, animations, and, of course, the 3D geometry of the objects that appear in the scene). Respective outputs may vice versa be converted, using respective conversion functionalities 140, e.g. COLLADA2GLTF, e.g. a custom converter to a GL Transmission Format file. A respective file may then be provided to a respective runtime application 150 or a plurality thereof, e.g. for a processing using a graphics API (e.g. OpenGL, WebGL, OpenGL|ES, Vulkan, Microsoft DirectX®).

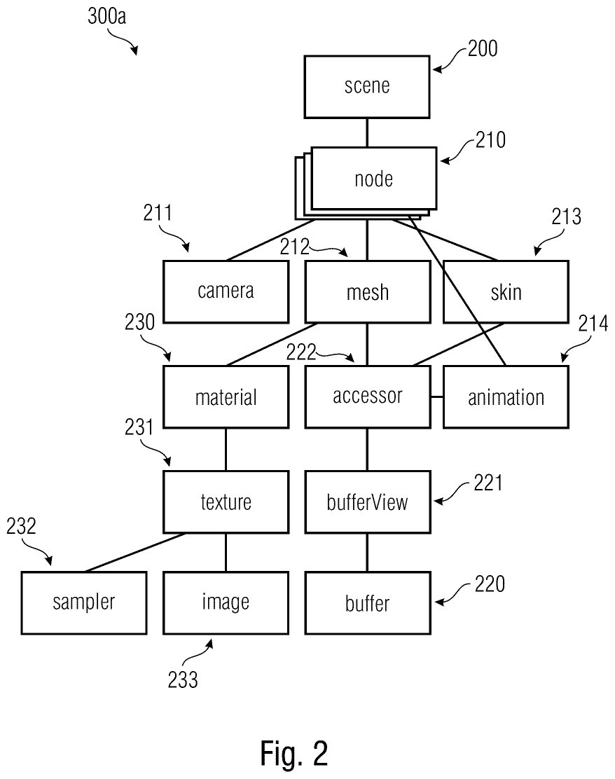

glTF (GL Transmission Format) is a specification designed to guarantee, or at least facilitate, the efficient storage, transmission, loading and/or rendering of 3D scenes and the contained individual models/assets by applications. glTF is a vendor and runtime-neutral format that can be loaded with minimal processing. glTF is aimed to help bridge the gap between content creation, e.g. 110, 130, and rendering. glTF is JSON formatted with one or more binary files representing geometry, animations, and other types of rich data. Binary data is stored in such a way that it can be loaded directly into GPU buffers without additional parsing or manipulation. The basic hierarchical structure of the data in the glTF format is shown in FIG. 2. In other words, FIG. 2 shows a schematic data structure, e.g. a hierarchical tree structure 300a, in glTF, according to embodiments.

In glTF, a scene, e.g. 200, consists of or comprises several nodes, e.g. 210 (e.g. as examples of scene elements). Nodes can be independent from each other or they can follow some hierarchical dependence defined in glTF. Nodes can correspond to a camera, e.g. 211, thus, for example, describing projection information for rendering. However, nodes can also correspond to meshes, e.g. 212 (e.g. describing objects) or skins, e.g. 213, (e.g. if skinning is allowed). When the node refers to a mesh and to a skin, the skin may, for example, comprise or contain further information about how the mesh is deformed e.g. based on the current skeleton pose (e.g. skinning matrixes). In such a case, a node hierarchy may be defined to represent the skeleton of an animated character. The meshes may contain multiple mesh primitives, which are, for example, the position of the vertices, normal, joints, weights, etc. In glTF, the skin may, for example, comprise or contain a reference to inverse bind matrices (IBM). The matrices transform the geometry into the space of the respective joints.

All data, such as mesh vertices, textures, IBM, etc. may, for example, be stored in buffers, e.g. 220. This information may be structured as bufferViews, e.g. 221, e.g. one bufferView is described as a subset of a buffer with a given stride, offset and length. An accessor, e.g. 222, may, for example, define the exact type and layout of the data that is stored within a bufferView. glTF links texture, e.g. 231, mesh information and further parameters to bufferViews, so that it is clear where the desired information can be found in the data present in the buffer(s). To be more concrete, a buffer may, for example, be split into one or more bufferViews, the later indicating which buffer they belong to the offset and length of the bufferView within the buffer, and the accessor indicating it belong to a bufferView (i.e. the bufferView could be split into one or more accessors) which indicates the offset within a bufferView, type of the data stored within the accessor (e.g. 3 floats indicating a vertex position, an integer indicating a property . . . ), etc.

Material, e.g. 230, which might include textures to be applied to rendered objects can optionally be also provided. The samplers, e.g. 232, may, for example, describe the wrapping and scaling of textures. The mesh may provide information of texture coordinates, which are used to map textures or subsets of textures to mesh geometry. Finally, glTF optionally supports pre-defined animations, e g. 214, using skinning and morph targets.

Hence, with regard to FIG. 2 it is to be noted that embodiments according to the invention may comprise scene descriptions based on a hierarchical structure comprising scene elements, such as nodes. In particular, a glTF scene description may be used, however, embodiments are not limited to the specific approach in glTF. The above is to be understood as an example of an optional basis of scene descriptions according to embodiments.

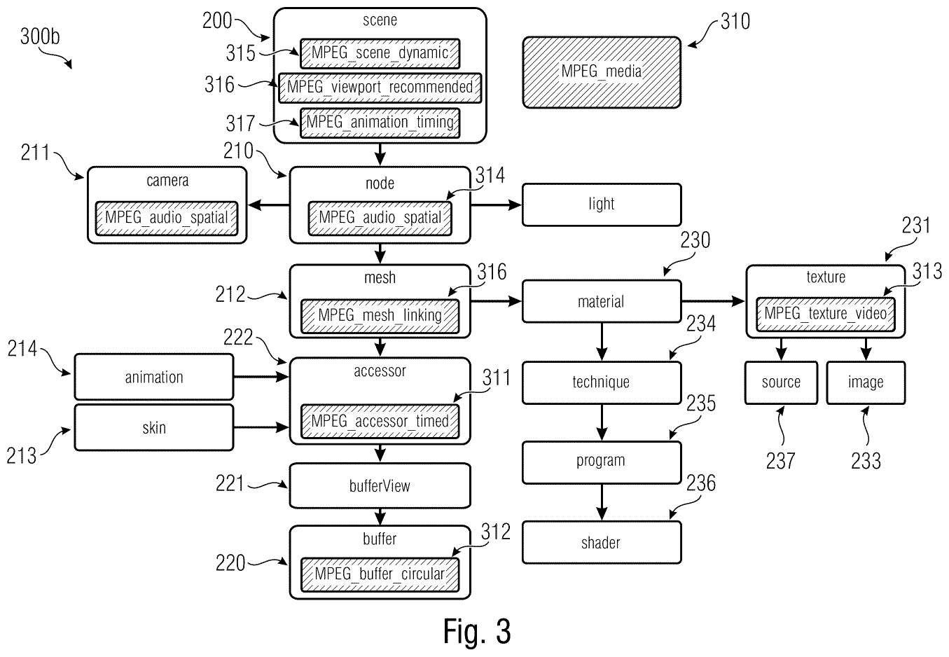

In the following, reference is made to FIG. 3. FIG. 3 shows a schematic block diagram of MPEG extensions, e.g. a hierarchical tree structure 300b, in glTF according to embodiments.

MPEG has developed a set of extensions that provide the ability of supporting dynamic data. Embodiments may comprise one or more of such extensions (e.g. individually or in combination). For completeness, the extensions are provided in the following:
MPEG_media, e.g. 310: used to reference external media (e.g., a video stream).
MPEG_accessor_timed, e.g. 311: used to indicate that the media described by the accessor element is timed.
MPEG_buffer_circular, e g. 312: used to store timed media in the buffer.
MPEG_texture_video, e.g. 313: used to provide a dynamic texture through buffers described by MPEG_accessor_timed, e.g. 311, and MPEG_buffer_circular, e.g. 312, extensions.
MPEG_audio_spatial, e.g. 314: used for spatial audio.
MPEG_scene_dynamic, e.g. 315: used for updating a 3D scene (i.e. updating the glTF file).
MPEG_viewport_recommended, e.g. 316: used to convey a recommendation for the viewport.
MPEG_mesh_linking, e.g. 316: used to link two meshes and provide mapping information.
MPEG_animation_timing, e.g. 317: used to control animation timelines.

Furthermore, additional scene elements, such as technique, e.g. 234, program, e.g. 235, and shader, e.g. 236 may be used, e.g. associated with a respective material information 230. Texture information 231 may, for example, further comprise an information about a texture source 237 and image information 233.

The set of the extensions and their placement in the node hierarchy (e.g. as discussed in the context of FIG. 2) is depicted by FIG. 3.

Here again it is to be noted that optionally, a scene description information according to embodiments may comprise a representation of the scene. Therefore, for example as shown

above, e.g. in FIGS. 2 and/or 3, the representation of the scene may be structured as a hierarchical tree structure comprising a plurality of scene elements, e.g. such as nodes 210, camera 211 mesh 212, . . . etc.

In other words, the scene may be represented by the plurality of scene elements of the hierarchical tree structure. Optionally, a neural network information according to embodiments may be an extension of such a scene element and the anchoring information may represent a position information of this scene element. Hence, the neural network information may be an extension similar to any of the extensions, e.g. 314, e.g. 316 etc. Furthermore, the neural network information may as well be provided in form of a plurality of extensions.

Alternatively, the neural network information may, for example, represent an individual scene element, e.g. in the form of a new attribute “neural_network”, of the hierarchical tree structure of the scene; and the anchoring information may represent a position information of this individual scene element.

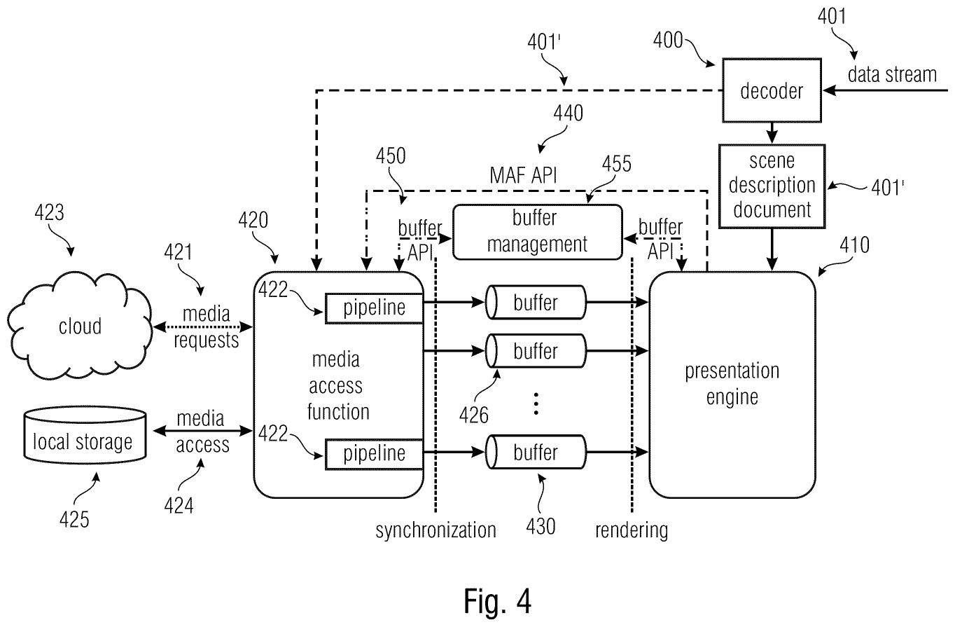

In the following, reference is made to FIG. 4, showing a schematic example of a basic architecture of glTF, according to embodiments. However, it is to be noted that this is just an example and that embodiments are not limited to the shown architecture (and hence in particular not to a specific glTF architecture).

Hence, in line with the above example, there is also a basic architecture based on whose principles the extensions (e.g. as discussed with regard to FIG. 3) are defined. It is assumed that there is a Presentation Engine, e.g. 410, (e.g. as an example of a renderer) that is responsible for doing the rendering of a scene (e.g. in an agnostic case). In addition, there is a Media Access Function (MAF), e.g. 420, (e.g. as an example of a preprocessing unit), that may take care of, optionally all, the media access and processing functions. The MAF is supposed or for example, configured to construct the so called media pipelines, e.g. 422. By doing so, it may be configured to, or may even need to transform the media from a delivery format into formats that can be rendered directly by the Presentation Engine. As an example, the Media Access Function may hence perform and/or manage media requests 421 to and/or from a cloud 423 in order to obtain the media. Alternatively or in addition, media access 424 may be performed using a local storage 425. The MAF, e.g. 420, may, for example, feed processed media, e.g. 426 into buffers, e.g. 430, which may be accessed by the Presentation Engine, e.g. 410, for rendering.

Furthermore, in the illustration of the architecture as shown in FIG. 4, the MAF API, e.g. 440, (e.g. a preprocessing unit API) may be configured to provide an interface between the Media Access Function 420 and the Presentation Engine 410. The Buffer API, e.g. 450, may be configured to allocate and control buffers 430 (e.g. providing a buffer management functionality 455) for the exchange of data between Media Access Function, e.g. 420, and Presentation Engine, e.g. 410.

As an example, a scene description information 401′ is provided to the presentation engine, in the form of a scene description document.

Optionally, as indicated in FIG. 4, a data stream 401 comprising an encoded version of the scene description information 401′ may be provided to a decoder 400 in order to obtain the scene description information 401′. The decoder 400 may optionally be configured, as explained before, to provide the scene description information 401′, or at least a portion thereof, e.g. a rendering information, e.g. a neural network information, e.g. an anchoring information, to the presentation engine, e.g. 410, and/or the media access function, e.g. 420, for example via one or more APIs.

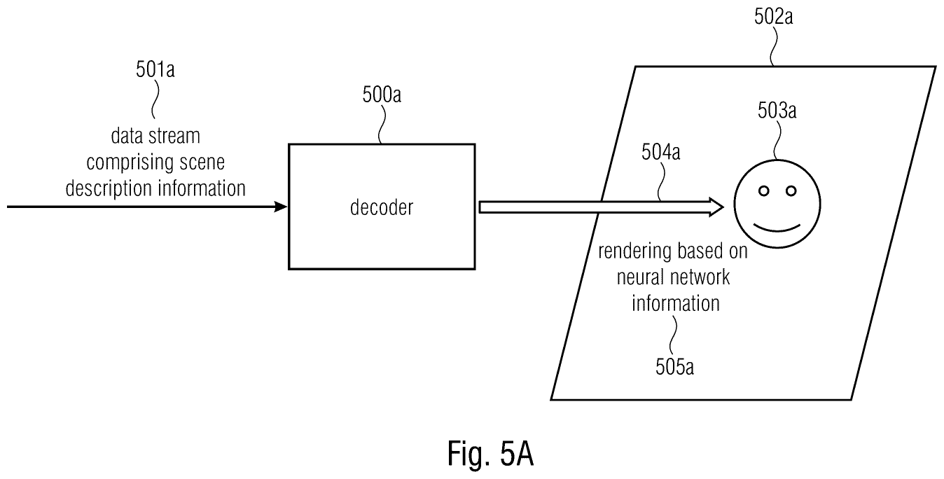

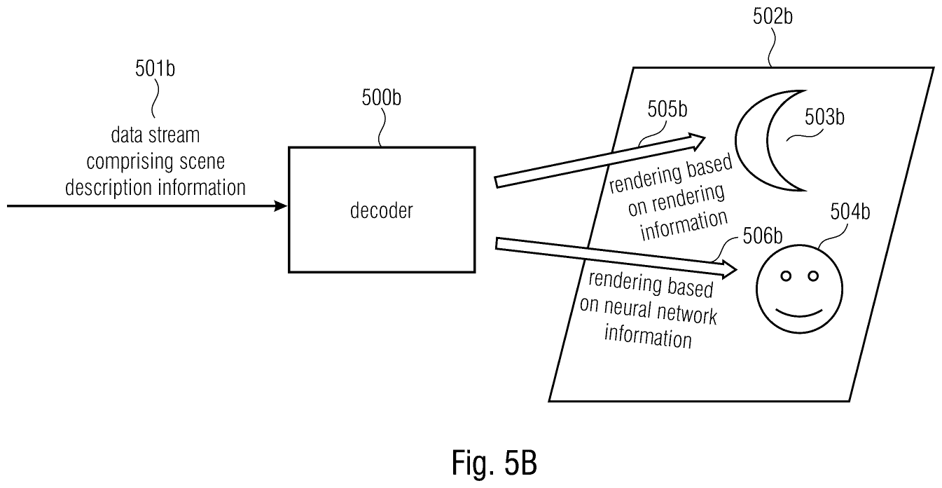

Next, reference is made to FIG. 5 a). FIG. 5 a) shows a schematic view of a decoder according to embodiments of the invention. As shown, a decoder 500a may be configured to decode, from a data stream 501a, a scene description information for a rendering of a scene 502a. The scene description information comprises a neural network information for a neural rendering (e.g. as indicated by arrow 504a) of an object 503a of the scene, and an anchoring information, which indicates a position of the object 503a within the scene 502a. Hence, a single object may be rendered into a scene. As an example, the neural rendering of the object may allow to exploit the advantages of inference based rendering for the manipulation of such an object together with the ability of placing said object at an arbitrary position, e.g. according to the anchoring information, within the scene.

In the following reference is made to FIG. 5 b), showing a schematic view of a decoder according to embodiments of the invention. Hence, a decoder 500b may be configured to decode, from a data stream 501b, a scene description information for a rendering of a scene 502b. As explained before, the scene description information comprises a rendering information for a rendering (e.g. as indicated by arrow 505b) of a first object 503b of the scene, the first object having a first position within the scene, a neural network information for a neural rendering (e.g. as indicated by arrow 506b) of a second object 504b of the scene, and an anchoring information, which indicates a second position of the second object within the scene.

Optionally, the scene description information may further comprise an additional neural network information for a neural rendering of an additional object of the scene 502b, and an additional anchoring information, which indicates a position (e.g. absolute position; e.g. relative position; e.g. relative position towards a viewer) of the additional object within the scene. In other words, in scene 502b additional objects may be present that may be rendered neurally based on the scene description information.

In particular, scene 502b may be rendered based on a mixed rendering. Therefore, the rendering information for the first object may optionally comprise an information about a mesh and/or about a point cloud of a representation of the first object. Hence, according to embodiments, the scene may be rendered using different rendering techniques, e.g. mesh or point cloud based rendering in contrast to neural rendering.

As another optional feature, the first and/or second object 503b, 504b may be a dynamic object, e.g. an object, which is changing over time in the rendered scene 502b.

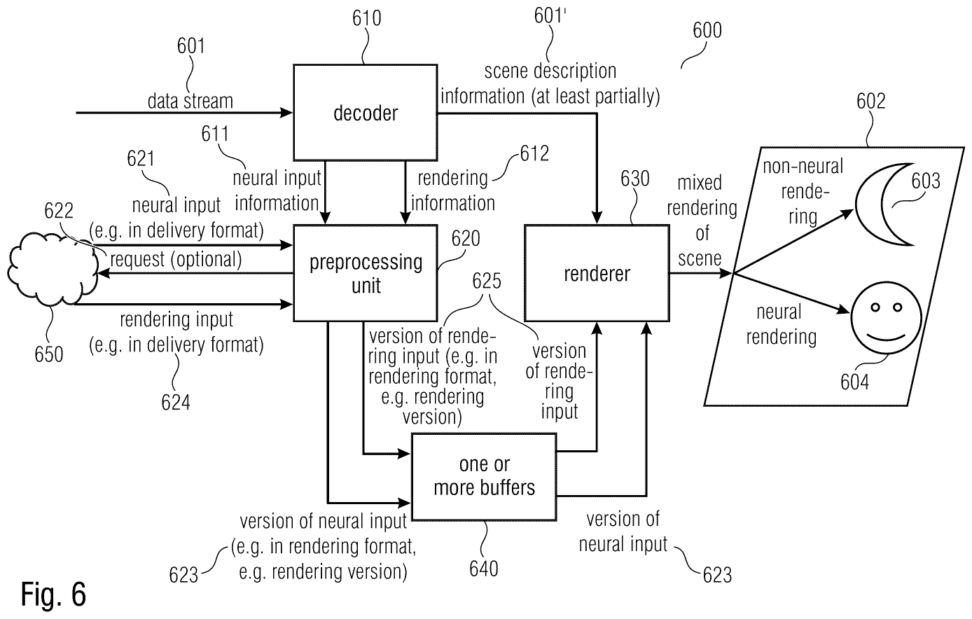

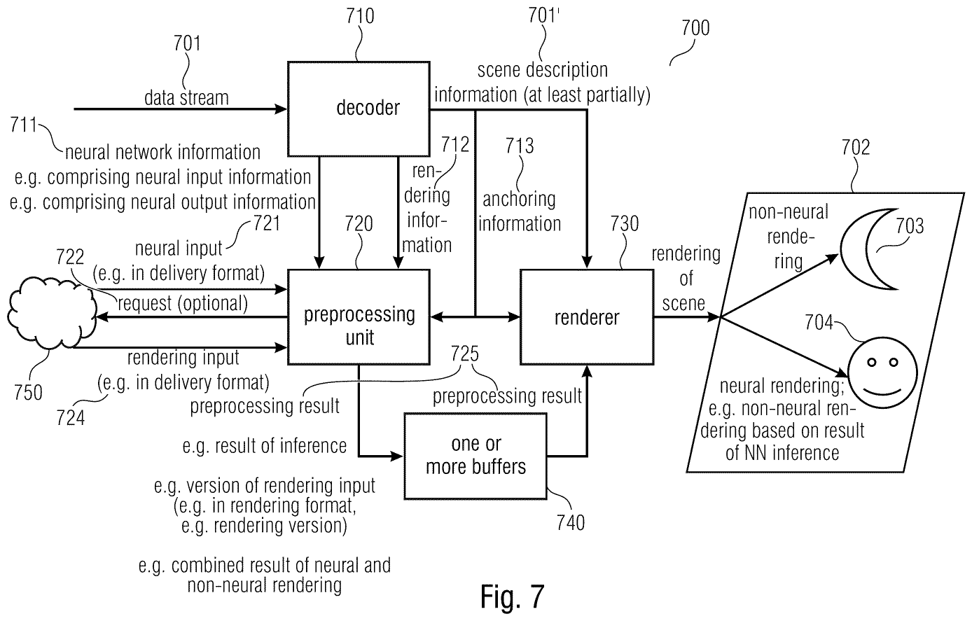

In the following, reference is made to further embodiments comprising a rendition of a first and second object, for example, in line with the embodiments as shown in FIG. 5 b). However, it is to be noted that respective features as disclosed in the context of FIGS. 6 and 7 may be implemented in a corresponding or identical fashion for embodiments in accord with the example of FIG. 5 a), e.g. except for the features regarding the rendering of the first object (and correspondingly features regarding a mixed rendering). Hence, as an example, embodiments which address a rendering of single object may have the features and functionalities as

discussed in the following disclosure, apart from the rendering information and respective derived information thereof which may hence result in a scene having only a rendition of the second object.

Next, reference is made to FIG. 6. FIG. 6 shows a schematic view of a system for performing an inference for the neural rendering in a renderer, according to embodiments. FIG. 6 shows system 600 comprising a decoder 610 and a preprocessing unit 620. Optionally, the system 600 may comprise a renderer 630 and/or one or more buffers 640.

Decoder 610 and scene description information may comprise respective features as discussed in the context of FIG. 5 a) and/or 5b). Furthermore, the neural network information optionally comprises a neural input information 611 indicating a neural input. This information is provided to the preprocessing unit 620.

The preprocessing unit 620 is configured to obtain the neural input 621, which is indicated by the neural input information 611. In the example, shown in FIG. 6, the neural input information may indicate a source, for example in a cloud architecture 650 (for example a local storage), from which the neural input, (for example, any kind of input data suitable for a neural network to perform the inference, e.g. a mesh, e.g. a 2D video, audio, e.g. a point cloud) can be obtained. As an example, the preprocessing unit 620 may be configured to obtain the neural input 621 via a request 622.

Optionally, however, the neural input may, for example, be already included in neural input information 611, so that the preprocessing unit may not have to request such information from another source, such as 650.

As an optional feature, the neural input 621 may be provided to the preprocessing unit 620, e.g. an MAF, in a delivery format, so that preprocessing unit 620 may optionally be configured to convert the neural input 621 to a rendering format. Hence, the neural input 621 and/or a version 623 of the neural input may be provided via the one or more buffers 640 to the renderer 630, e.g. a Presentation Engine. As another optional feature, the decoder 610 is configured to provide the rendering information 612 to the preprocessing unit, which is configured to derive, e.g. to obtain, from the rendering information, a rendering input 624 in the form of a mesh, a 2D video/audio and/or a point cloud, and to provide a version of said rendering input, via the one or more buffers 640, to the renderer 630. In line with the above explanations, the rendering input may be included in the rendering information 612, or as shown, may be obtained, for example via a request from a different source. Optionally, the rendering input may as well be obtained first in a delivery format and therefore be converted to a rendering format 625 for the provision to the renderer 630.

As an optional feature, renderer 630 is configured to perform a mixed rendering of the scene 602 including a rendition of the first object 603 based on the version 625 of the rendering input and a neural rendition of the second object 604 based on the version of the neural input 623. Furthermore, for the rendering, the scene description information may be provided at least partially (601′) from the decoder 610 to the renderer 630, for example in particular the neural network information and the anchoring information, in order to perform the mixed rendering. Hence, based on the anchoring information, the first object may be rendered at the first position in the scene and the second object may be rendered at the second position in the scene.

It is to be noted that optionally, e.g. alternatively, the neural network parameters and/or topology information may be provided by the preprocessing unit to the renderer 640. The preprocessing unit 620 may be provided by decoder 610 with a referencing information on where to obtain the neural network parameters from, and may hence provide the same to the renderer. However, the renderer may as well be configured to perform such a functionality.

Accordingly, as shown in FIG. 6, the scene 602 may be rendered using a non-neural rendering for the first object 603 and using a neural rendering for the second object 604.

As an example, a result of the neural rendering of the second object 604 may, for example be, a 2d image (e.g. in the form of a simple mesh comprising or even consisting of a single plane, wherein the 2d image provided by the NN may be used as the texture of the plane) of which the position in the rendered scene 602 is set in accord with the anchoring information.

Furthermore, optionally, the scene description information may comprise an indication, e.g. a mode meaning NN_rendering, that a mixed rendering is to be performed and the decoder 610 may be configured to provide the indication to the renderer 630, e.g. as part of the at least partially provided scene description information 601′; and the renderer 630 may be configured to, based on the indication, combine, e.g. based on an depth and/or transparency information, the renderings, e.g. renditions, of the first and second object 603, 604 of the scene 602 in a superposed manner.

Hence, in general, a fusion of non-neurally rendered and neurally rendered images or portions thereof may be performed in any suitable manner, e.g. in a superimposed manner, e.g. using overlaying techniques, or for example, based on an extraction of an object and insertion into another image or portion thereof.

Next, reference is made to FIG. 7. FIG. 7 shows a schematic view of a system for performing an inference for the neural rendering in a preprocessing unit, according to embodiments. FIG. 7 shows system 700 comprising a decoder 710 and a preprocessing unit 720, e.g. MAF. Optionally, the system 700 may comprise a renderer 730 and one or more buffers 740. Decoder 710 and scene description information may comprise respective features as discussed in the context of FIGS. 5 and/or 6.

According to the embodiment as shown in FIG. 7, the decoder 710 is configured to provide the neural network information 711 to the preprocessing unit 720, which is configured to perform an inference for the neural rendering based on the neural network information and a neural input. Hence, in contrast to the embodiment as shown in FIG. 6, the inference for the neural rendering may be performed in the preprocessing unit, aside from the renderer 730.

Again, the neural network information 711 may comprise the neural input 721, or for example a reference on where to obtain such an input 721, e.g. via a request 722, form a source, such as a cloud 750. In other words, optionally, the neural network information 711 may comprise a neural input information indicating the neural input 721 based on which the inference is to be performed for the neural rendering. Accordingly, e.g. as explained in the context of FIG. 6, a rendering input 724 may be obtained based on a rendering information 712. Neural input 721 and/or rendering input 724 may be obtained in a delivery format and subsequently converted by preprocessing unit 720 into a rendering and/or processing format.

As an optional feature, the neural network information 711 may comprise a neural output information defining (or for example indicating) a format, e.g. a mesh format, e.g. a point cloud format, of an output of the neural rendering and the preprocessing unit, e.g. a MAF, may be configured to provide a result of the inference (e.g. being or being included in preprocessing result 725) in the format as defined by the neural output information via the one or more buffers 740 to the renderer 730, e.g. a Presentation Engine.

Examples for such output formats are meshes, point-clouds, 2D images, animated 2D images, animated meshes, illuminated meshes, illuminated 2D images, opacity dependent colors and/or viewing direction dependent colors.

Hence, in other words, the neural rendering, e.g. in the form of an inference thereof, may optionally be performed by a preprocessing unit 720, providing an output to the renderer in a format, which may be similar or even identical to the rendering input for the rendering of the first object 703. In other words, the embodiment according to FIG. 7 may show an agnostic approach, in that the renderer 730 might not be aware that a neural rendering, e.g. an inference for a rendering of the scene 702, is performed. The renderer 730 may be provided by the preprocessing unit 720 with a version of the rendering input, for example a mesh and/or a point cloud, for the non-neural rendering of the first object 703 and a result of the inference in the form of, for example, a mesh and/or a point cloud, so that the rendering of the second object 704 can be performed in a similar or even identical fashion to the rendering of the first object.

The rendering of scene 702 may be interpreted as a mixed rendering, since the rendering of the second object 704 may be a neural rendering in so far, that an underlying rendering input for renderer 730 may be obtained using a neural network.

For the rendering of scene 702, as another optional feature, the preprocessing unit 720 and/or the renderer 720 may be configured to use the anchoring information 713 in order to place the second object 704 at the second position within the scene.

As an example, the renderer 730 may be provided with the anchoring information 713 from the decoder 710, in order to position the second object 704 in the scene 702 according to the second position. Additionally, or alternatively, the decoder 710 may be configured to provide the anchoring information 713 to the preprocessing unit 720, which may determine a mesh and/or point cloud representation of the second object 704, and the anchoring information may be included in the mesh and/or point cloud representation, so that the anchoring information is provided in the form of the mesh and/or point cloud representation from the preprocessing unit 720 via the buffers 740 to the renderer 730.

In simple words, the anchoring information 713 may hence be incorporated in the processing of the system 700, in that a result of the inference, e.g. a mesh and/or point cloud may comprise the information about the positioning of the second object. Alternatively, the information may be directly provided to the renderer 730.

The renderer 730 may hence be configured to perform the rendering of the scene 702, including a rendition of the first object 703 based on the information about the rendering input 724 e.g. in the form of a mesh and/or a point cloud and a rendition of the second object 704 based on the information about the result of the inference in the form of the mesh and/or the point cloud.

With regard to the buffers, e.g. as discussed in the context of FIG. 6 or 7, it is to be noted that in general, the output format, defined by the neural output information, may comprise a plurality of different output attributes and the neural network information may comprise an information about a plurality of different buffers and/or an information about a plurality of different subsections of buffers in which a respective different attribute is to be stored. Hence optionally, a respective preprocessing unit may be configured to store a respective different attribute in accordance with the neural network information in different buffers and/or in different subsections of buffers; and a respective decoder may be configured to provide the neural network information to the renderer, in order for the renderer to obtain the result of the inference from the respective buffer or respective subsection of a buffer.

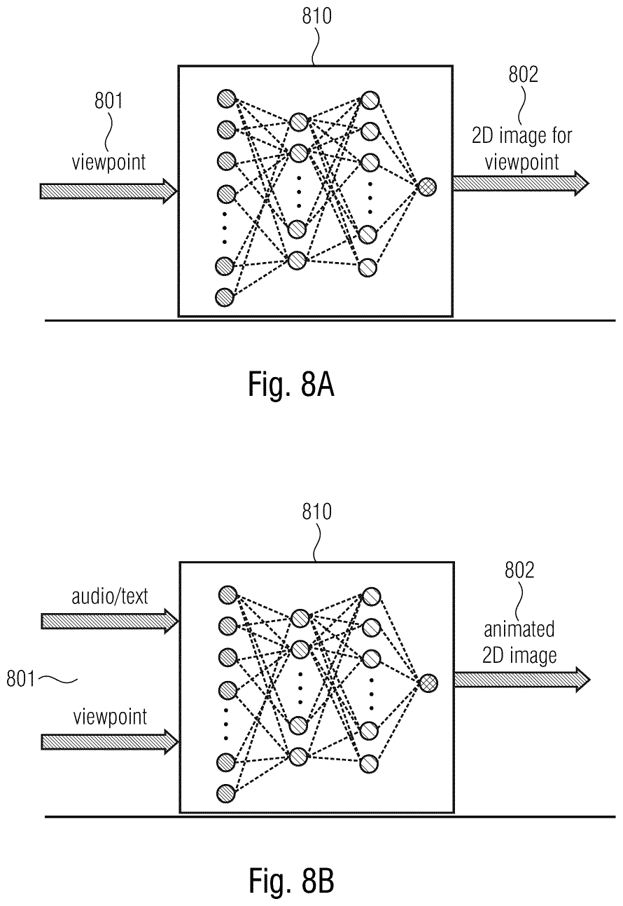

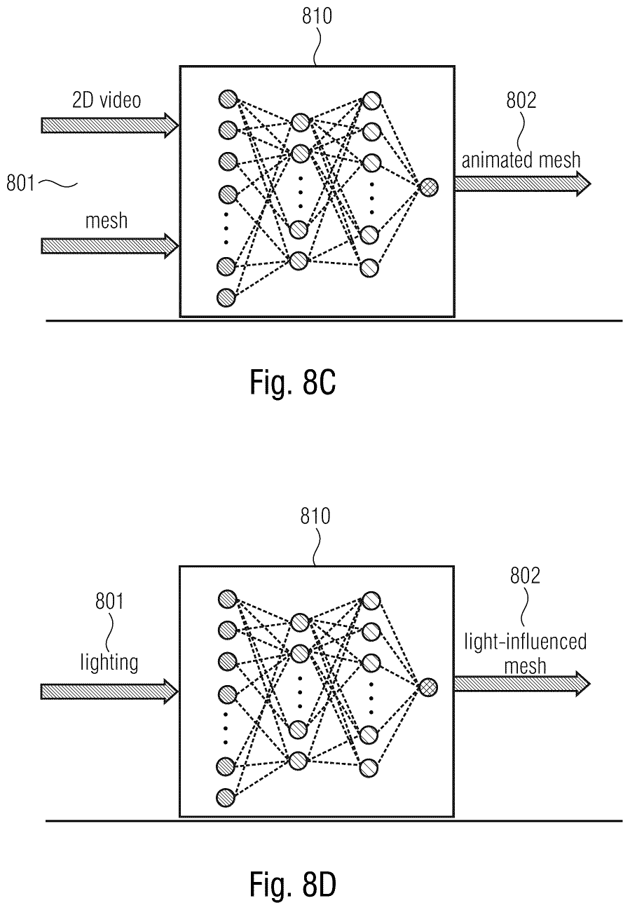

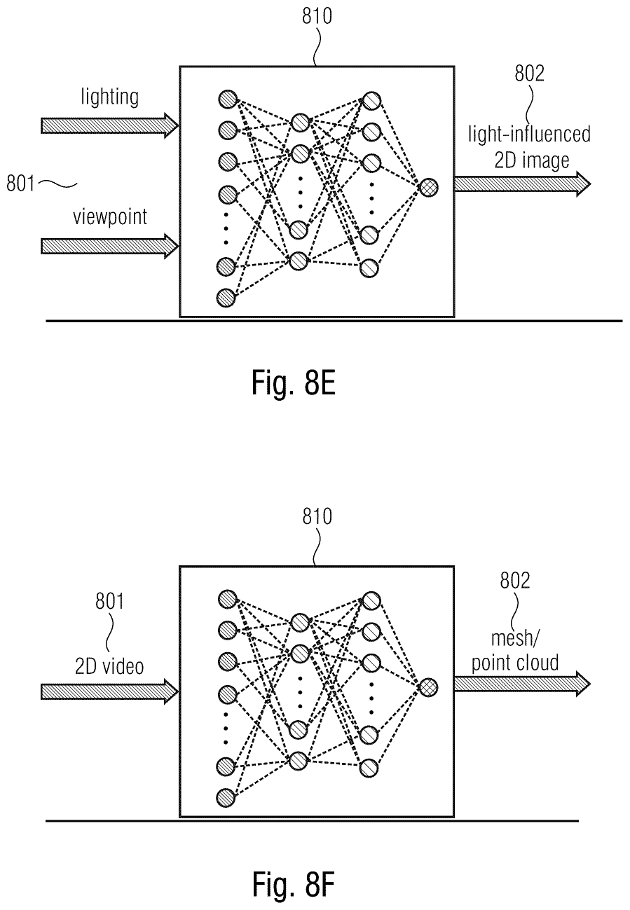

In the following, schematic examples of applications and NN rendering approaches according to embodiments are discussed, in particular with regard to FIGS. 8 a) to f) and 9. Accordingly, examples of applications and NN rendering approaches according to embodiments can be very diverse. The following inputs and output examples may be used for any of the above explained embodiments, e.g. according to FIGS. 4, 5, 6 and/or 7.

FIG. 8 a) to f) show examples of respective inputs 801 for a neural network, NN, 810, and respective outputs 802, according to embodiments.

FIG. 8 a) shows a schematic example of a NN 810 taking as input 810 a viewpoint, outputting, 802, an animated 2D Image (e.g. a 2D image for the viewpoint). In other words, the example in FIG. 8 a) shows a NN 810 that takes as input 801 a viewpoint (i.e. viewing position or relative distance from the viewer to an object or within the scene that the NN renders) and outputs, 802, an image of an object/scene.

FIG. 8 b) shows a schematic example of a NN 810 taking as input 801 a viewpoint and audio and/or text and outputting, 802, an animated 2D Image. In other words, the example in FIG. 8 b) shows a NN 810 that takes as input a viewpoint (i.e. viewing position or relative distance from the viewer to an object or within the scene that the NN renders) and audio or text and outputs an image of an object/scene that is animated based on the audio and/or text. An example of such an animated 2D output could be a person that moves its hands or lips based on the audio or text that such a person would be saying. Obviously, any media could be used as input instead of audio or text, as for instance a 2D video or image.

Also, the output, 802, could be instead of a 2D image of a particular viewpoint a mesh or a point cloud. This is illustrated in FIG. 8 c). FIG. 8 c) shows a schematic example of a NN, 810, taking as input, 801, a mesh and a 2D video and outputting, 802, an animated mesh.

In other words, the example in FIG. 8 c) shows a NN 810 that takes as input 801 a mesh (e.g. something like an avatar) and 2D video (e.g. illustrating how the avatar should move) and outputs, 802, a mesh that is animated based on the 2D video. In such an example the video would, for instance, represent the view of a particular person at a particular viewpoint and the mesh of that person could be modified following the 2D video of that particular position allowing to render such a mesh with the corresponding movements from any other position.

Most of the above show how NN can be used for rendering a 2D image of an object/scene that is animated by some input data. However, more applications exist, e.g. for using light information of a new environment, to re-illuminate an object. For instance, in a Mixed Reality or Augmented reality scenario an object generated by an NN could be placed within the room of the user with each user having different light sources with different characteristics.

FIG. 8 d) shows a schematic example of a NN 810 taking as input 801 lighting parameters and outputting, 802, a light-influenced mesh. In other words, the example in FIG. 8 d) shows a NN 810 that takes as input 801 lighting parameters (e.g. position of light sources, type/intensity of light sources, directions) and outputs, 802, a mesh that is illuminated based on lighting. In such an example the mesh would, for instance, show some reflectance or lighter or darker spots based on the light information. It also could output a 2D image instead.

A further example is illustrated with an additional input 801 in FIG. 8 e), where in addition to the lighting parameters a viewpoint is input to the NN, 810, and the output, 802, is the view (2D image) that a user has when at that viewpoint with the lighting information provided. In other words, FIG. 8 e) shows a schematic example of a NN 810 taking as input 801 lighting parameters and a viewpoint and outputting, 802, a light-influenced 2D image of a view from a viewpoint.

Further examples can include also the generation of meshes or point clouds from 2D videos as shown in FIG. 8 f), and so on. Accordingly, FIG. 8 f) shows a schematic example of a NN, 810, taking as input, 801, a 2D video and outputting, 802, a mesh or a point cloud,

It is to be noted that embodiments optionally comprise different combinations of the examples for inputs and/or outputs of the above. In particular, embodiments as discussed in the context of FIGS. 6 and 7 may comprise a neural input which comprises one or more of the above discussed inputs 801 and accordingly a result of the inference may be provided in any format of any of the above outputs 802.

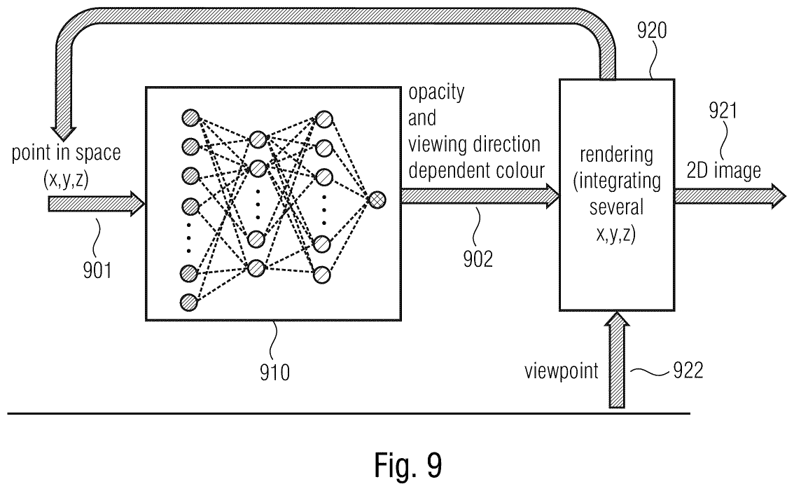

In addition, embodiments optionally comprise more complex rendering steps based on NN. One example thereof is illustrated in FIG. 9. FIG. 9 shows a schematic view of an example of a NN 910 taking as input 901 a point in the space (e.g. controlled by renderer) and outputting, 902, an opacity and colour dependent on viewing direction, according to embodiments.

In the example in FIG. 9, a renderer 920 is configured to compute a 2D view, 921, related to a particular viewpoint, 922, by integrating characteristics (e.g. opacity and viewing direction dependent colour, e.g. as provided by the output 902 of the NN 910) or one or more points in the space based on the viewpoint of the user. Such an approach corresponds to a very promising technique called Neural Radiance Fields (NeRF).

Referring to FIGS. 8 a) to f) and 9, it is to be noted that in general, optionally, the neural input may comprise at least one of a viewpoint information (or example a viewing position or for example a relative distance from a viewer to the second object), an audio information, a text information, a mesh, a point-cloud; a 2D video, and lighting parameters (for example a position of a light source and/or for example a type and/or intensity of a light source and/or for example a direction of a light source).

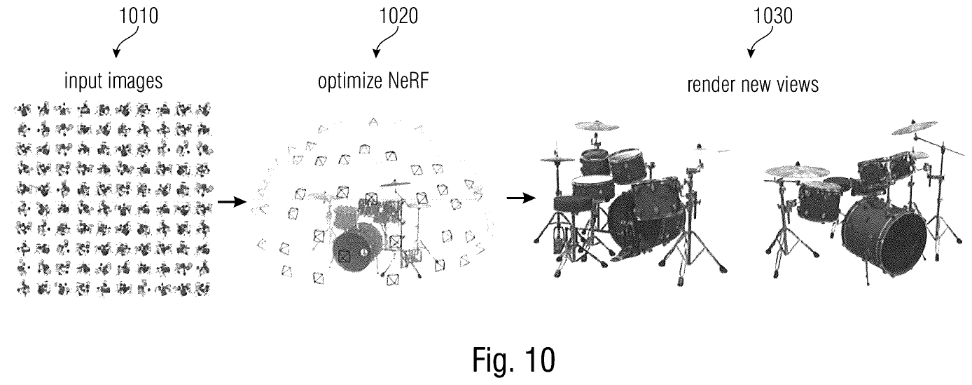

Next, reference is made to FIG. 10. FIG. 10 shows a schematic example of a basic principle of NeRF, according to embodiments of the invention.

As a yet further option for the output of the NN is the case that the NN renders a 2D view for a particular viewpoint (x, y, z) and viewing direction (θ, φ). This is the case of new technologies such as NN-based Radiance Fields, e.g. NeRF ([1]) or its various derived formats ([2], [3]). Unlike point cloud or polygon meshes, these technologies do not rely of an explicit 3D representation in order to render views of an object or a scene. Instead, they use one or more NN to generate a 2D image containing a camera view of a scene encoded into the parameters of the NN. For this purpose, the scene is regarded as consisting of some sort of particles with view-direction dependent colour and opacity/density information, in other words, information about the radiance field of the scene. The position and direction of the rendered camera viewpoint can be updated over time, therefore obtaining the illusion of viewing a 3D object.

The input of the NN may, for example, be a sparse set of 2d images, e.g. 1010, of an object or scene. Once trained (e.g. so that the scene may be rendered from a multitude or even arbitrary point of view as indicated in portion 1020 of FIG. 10), the NN may be able to infer novel views (as 2d images), e.g. 1030, that were not present in the original dataset, e.g. 1010. FIG. 10 shows this principle.

NeRF was initially created as a viewpoint-dependent NN graphic representation for static scenes with simple objects. This concept has evolved over time, allowing the inclusion of dynamic content, complex scenes and manipulation of the elements in different ways, such as separating objects from the background. NeRF does not rely, initially, on an explicit 3d representation, even though it can provide depth information.

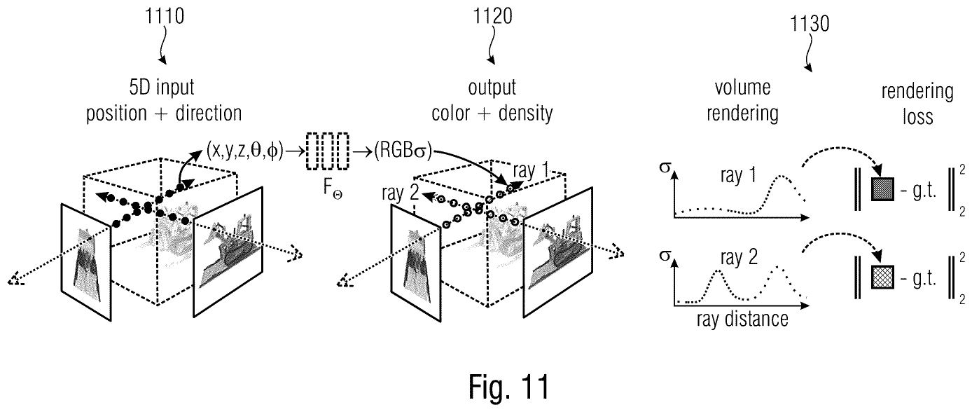

In order to achieve the generation of novel views, NeRF uses a method based on the use of radiance fields. From a specific viewpoint and viewing direction, a set of rays will be cast towards each of the positions of the image. Each ray will detect the collision with the object and, together with the information provided by the rest of the rays, will calculate the color of each pixel of the resulting image, as well as its volume density. This allows the output 2d image to accurately represent the color, transparency and reflectance of the object or scene. FIG. 11 shows a description of this method. FIG. 11 shows a schematic example of a description of the inputs and outputs of the NN in NeRF, according to embodiments.

As mentioned, NeRF takes only the viewpoint to set for each sample in a 2D image a ray for which several point positions are derived and view direction (x, y, z, θ, φ) (see. e.g. 1110) that are used as an input to the NN and this generates an opacity value a colour of such a point (see e.g. 1120) with such a direction which is integrated (see e.g. 1120 and 1130) over several points reaching with several rays the rendered view as a 2d image.

However, such a technology can be extending with further inputs as described above to enhance the output of the NN-based rendering, such as by performing animations based on text, audio or video, or performing some re-lighting, etc. So multiple combinations are envisioned by adding additional inputs to the NN.

Hence, it is to be noted that embodiments according to the invention may comprise NeRF rendering functionalities, e.g. performed by a preprocessing unit and/or a renderer, for example for the rendition of the second object.

Further aspects and embodiments according to the Invention:

### 1. General NN Integration for 3D Assets

As can be seen from the description of multiple NN-based rendering applications in the examples, in order to efficiently integrate NN into a scene, a lot of information may be conveyed

or may, for example even need to be conveyed to the rendering engine, e.g. renderer, or rendering application, e.g. in the form of a scene description document (e.g. as an example of a scene description information), as for instance glTF.

One of such would be the position within a scene of the rendered object(s) by a NN or somehow the relative position thereof towards the viewer.

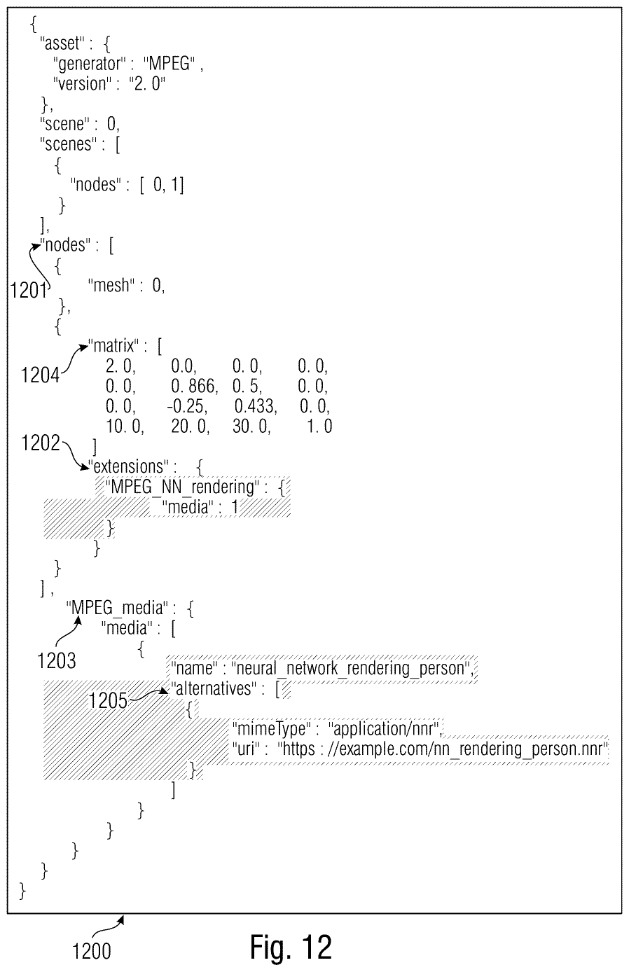

In a first embodiment, a NN is embedded into a scene description file (e.g. scene description document, e.g. as an example of a scene description information) for rendering one or more objects. As such, the NN may be anchored or may, for example, even need to be anchored to a scene, or to a position in a scene, for example either adding a new attribute (e.g. a scene element) to the scene description called, for instance, “neural_network” with a position within the space described by the scene, or, for example, attaching it to a node (e.g. as an example of a scene element), which per se has a position within the scene (see FIG. 12).

FIG. 12 shows a first example (e.g. Example 1) of a code for a scene description according to embodiments. In particular, FIG. 12 shows an example for a glTF file (e.g. as an example of a scene description information 1200) with NN rendering attached to a node.

As described, an aspect of the embodiment is that the rendered objects/parts of the scene are given a particular position in it. For doing so, a node, e.g. 1201, of the scene in glTF is mapped to a NN so that the output of the NN is placed at the position of the node. This can be done, for instance, by defining an extension, e.g. 1202, to a node object of the glTF file. Such an extension is illustrated in the example of FIG. 12.

Note that, in the example, a single media, e.g. 1203, is offered for simplicity, which contains the NN, as an example, for rendering a person. A node, which is positioned in a scene at a particular place determined by the matrix, e.g. 1204, is mapped to the NN by the defined extension, which points to the media that comprises or contains the NN for rendering. The extension itself may, for example, indicate that it is a NN that needs to be executed to generate a particular content. As mentioned, other options would be to define a new attribute particularly for neural_rendering and attach to it a position within the scene. Further options could be to add extensions to existing object representations such as meshes or point clouds. In this case, some aspects of these objects could be modified by the NN. Although the NN extension has been provided in the example above as part of a node, it could be also placed as part of a mesh as already mentioned, for instance, or as a point cloud. If the extension for NN rendering was to be added directly to a mesh or a point cloud the additional association to the mesh would, for example, be intrinsic to the position of the extension (mesh, node, camera . . . ).

It is important to note that the NN may, for example, have to be offered for a client to be downloaded or accessed. This could be done (e.g. is done according to embodiments) basically by embedding the NN as a binary into a buffer within the scene description document. Also, there might happen that devices exist that do not have the capabilities, e.g., in terms of hardware, of being able to do inference on the NN for rendering and a, for example better, alternative would be to offer it as one option to be used, e.g. in the form of a URL to download. Thus, such low capability devices would have to, or could, resort to other mechanism, such as using traditional polygon mesh or point cloud representations. Therefore, in a further aspect of an or the embodiment, the NN (e.g. in the form of neural network information 1205) for rendering is provided in the glTF file as an option to be downloaded, for example, in case the end-device is able to use it for rendering parts of the scene (which is illustrated in FIG. 12 as one of the alternatives).

In general, it is to be noted that the neural input information optionally comprises at least one of an index and/or ID to a buffer comprising a media data, and an index and/or ID to a media stream, for example, to be used as input for NN (e.g. for the neural rendering). Hence, e.g. instead of an uri, in FIG. 12, the input may be indicated by an ID, which may identify the input itself, or just a source thereof.

As already discussed in the many examples, NN-based rendering may be based on a great variety of possible inputs. Therefore, in addition to the position of an object to be rendered with NN within the scene, the input of the NN may be, or may, for example, even need to be indicated.

This could be as examples in the figures (inter alia, e.g. 8 a) to f); e.g. 9) described before (at least one of the following):
Viewing Point
Time instant
Particular media:
   Audio driven: an animation of an object based on the audio component
   Video driven: e.g., a 2D video whose movements are applied to a volumetric video/object
   Imager drive: e.g., when a static image is used to be able to render the volumetric object
   A 3D object described in any way (e.g. mesh/texture, point cloud, etc.)
Lighting information

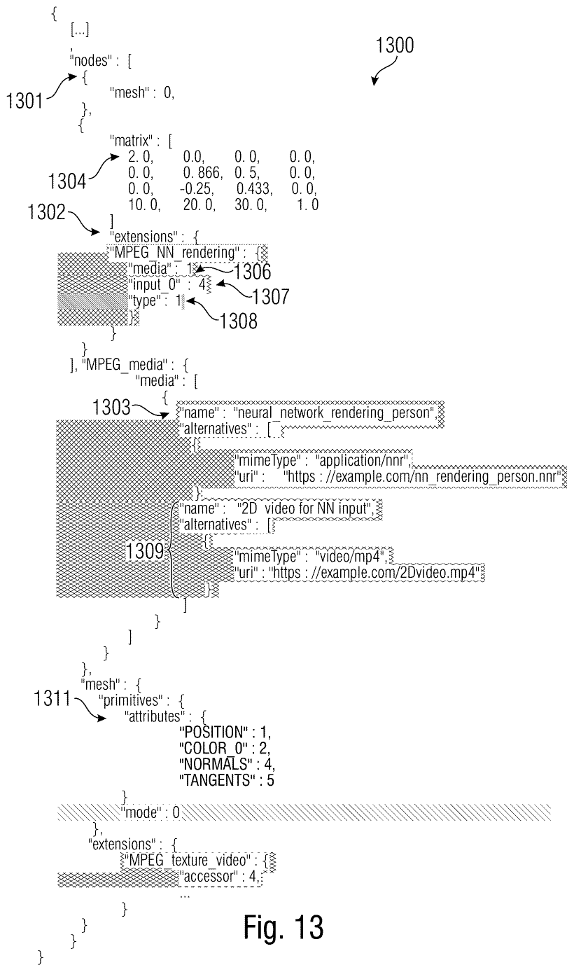

As a further aspect of an or this embodiment and indication of the input to the NN or association to an element/attribute of the scene description document used as an input may optionally be provided. An example is shown in the following, see FIG. 13, for a 2D video that is handled by accessor number 4 used as an input.

FIG. 13 shows a second example (e.g. Example 2) of a code for a scene description according to embodiments. In particular, FIG. 13 shows an example of a glTF file (e.g. as an example of a scene description information 1300) with NN rendering attached to a node indicating that the input is a 2D video. Elements 13xy of FIG. 13 may correspond to elements 12xy in FIG. 12, e.g. apart from the specific features of node extension 1302 and optional mesh attributes 1311 (e.g. as an example of attributes of an output format).

The example assumes that the 2D video (e.g. a reference to which is provided in section 1309) is decoded and stored in accessor number 4, as a sequence of images and those are used as by the NN since “input_0”, e.g. 1307, indicates an index of the accessor at which the data is stored. Another option could be that the index points to one of the listed media elements, which in that case would, as an example, require the input of the NN to decode the video and make it available to the NN without using the buffer structures in glTF.

Note that, as an example, only one input is indicated. One option would be to assume that it is clear that the viewing position of the user may, for example, need also to be provided.

However, there might be cases (see e.g. FIG. 8 c)) for which the whole mesh is output by the NN and therefore the viewing position is not necessary. However, in other cases (see e.g. FIG. 8 a)) it may, for example, be necessary to use the viewpoint of the user for the NN rendering. Therefore, an additional information may, for example, be or may even need to be included into the scene description document indicating further inputs. One option could be to indicate a “type” element, e.g. 1308, as shown in the example, for which 0 could be no further input and 1 could be the viewpoint of the user needs to be input to the NN.

Hence, in general, optionally, the neural input information may comprise an information, e.g. “type”, about an amount of inputs that are to be considered for the determination of the neural input.

Similar to what is discussed above with respect to the input of the NN, the output of the NN may, for example, be crucial for rendering.

In the following subsections, different aspects of the invention are described by using two different approaches:
Buffers may, for example, be re-used and fed by a NN with a defined rendered media format (e.g., 2D texture, or 3D mesh+texture) so that the Presentation Engine may work as usual with such traditional media formats. In this case, the NN may be responsible for outputting a format that matches the “typical” formats (e.g. meshes, point clouds) used by rendering engines.
NN rendering may, for example, be used and combined with further objects of the scene with the regular Presentation Engine process. In this case, the rendering engine needs to handle both typical formats and processing and NN based rendering processes.

Depending on the envisioned architecture or integration with the presentation engine, different options according to embodiments exist.

### 2. Integration of NN Reusing Buffers

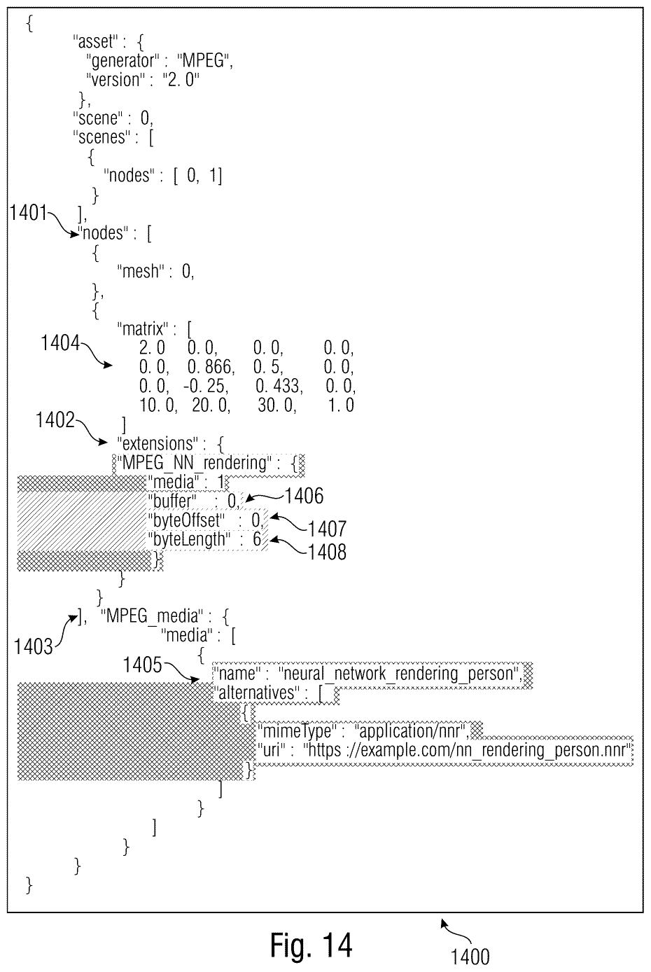

If the presentation engine is made “agnostic” about the NN rendering, i.e., the NN generates the content into a buffer that the presentation engine reads for rendering the whole scene, the output of the described NN may be or may, for example, need to be attached to a buffer in glTF. In that case, the Media Access Function (MAF) may be responsible for making use of the NN and making sure that the output is stored into the buffer for the Presentation Engine to be able to make use of the rendered content. An example of this, based on the one mentioned above, is shown in FIG. 14.

FIG. 14 shows a third example (e.g. Example 3) of a code for a scene description according to embodiments. In particular, FIG. 14 shows an example of a glTF file (e.g. as an example of a scene description information 1400) with NN rendering attached to a node indicating that the output needs to be stored within buffer 0. Elements 14xy of FIG. 14 may optionally correspond to elements 12xy in FIGS. 12 and/or 13xy in FIG. 13, e.g. apart from the specific features of node extension 1404.

In the example, there is a reference, e.g. 1406, to the buffer in which the NN renders the data, as well as the position, e.g. 1407 within the buffer (byteOffset) and the length, e.g. 1408. In addition, further parameters could be given, such as stride. It could be also the case that instead of having a single buffer, multiple buffers are used. For instance, one for the texture, one for the mesh vertices, etc. Alternatively, instead of pointing directly to buffers one could point directly to an accessor, so that it is clear that the data is output in the subset of a buffer that corresponds to the accessor. As such, also the format of the output data and how this needs to be stored within the buffers would be provided.

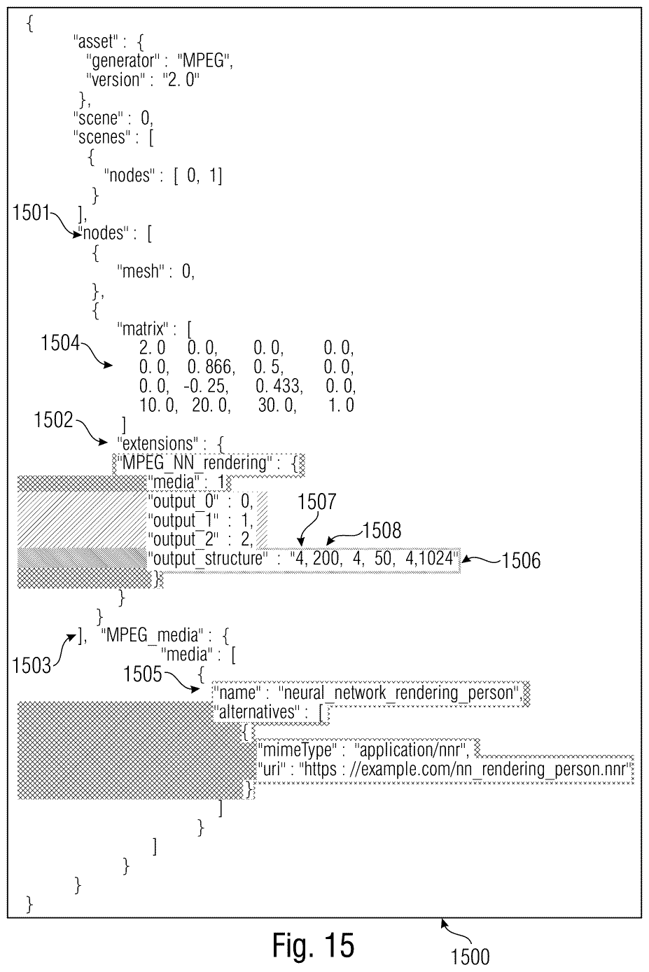

Reference is made to FIG. 15. FIG. 15 shows a fourth example (e.g. Example 4) of a code for a scene description according to embodiments. In particular, FIG. 15 shows an example of a glTF file (e.g. as an example of a scene description information 1500) with NN rendering attached to a node indicating that the output needs to be stored within different accessors with index 0, 1and 2. Elements 15xy of FIG. 15 may optionally correspond to elements 12xy in FIG. 12 and/or 13xy in FIG. 13 and/or 14xy in FIG. 14, e.g. apart from the specific features of node extension 1504.

Note that in order to store the output of an NN into several buffers/accessors, it would be beneficial, or for example, even necessary to know how the output of the NN is structured. One could assume, it is known which part of the output describes what; but alternatively an information may, for example, need to be added to describe such an output and allow the end device (e.g., MAF) to store the output (e.g. in particular parts thereof) into separate buffers/accessors. In FIG. 15, e.g. example 4, this is carried out by “output_structure”, e.g. 1506, with uses pairs of numbers to indicate the type of the data (e.g. 1507, e.g. float using 4 bytes) and the number of elements, e.g. 1508, that each part consists of (200, 50 and 1024 for each of the outputs in the example above).

Or in addition, one could provide (e.g. in accord with embodiments) a mapping between a particular NN used for rendering and a mesh or point cloud to perform the association, for instance by means of an index to the mesh/point cloud.

One of the issues with this approach is that the presentation engine may need to be made aware of how to render the data in the buffer together with the rest of the scene. And this may depend on the structure of the data that is output by the NN.

### 1) Mesh and Texture

A first option according to embodiments is that the data output of the NN represents a mesh. In order to represent a mesh at least the following components may be indicated, or may, for example even required: vertices of a mesh (e.g., describing the corner points of triangles or polygons), a texture and texture coordinates. The latter two describe how to map parts of the full texture to each of the surfaces (e.g., triangles, polygons) of the mesh.

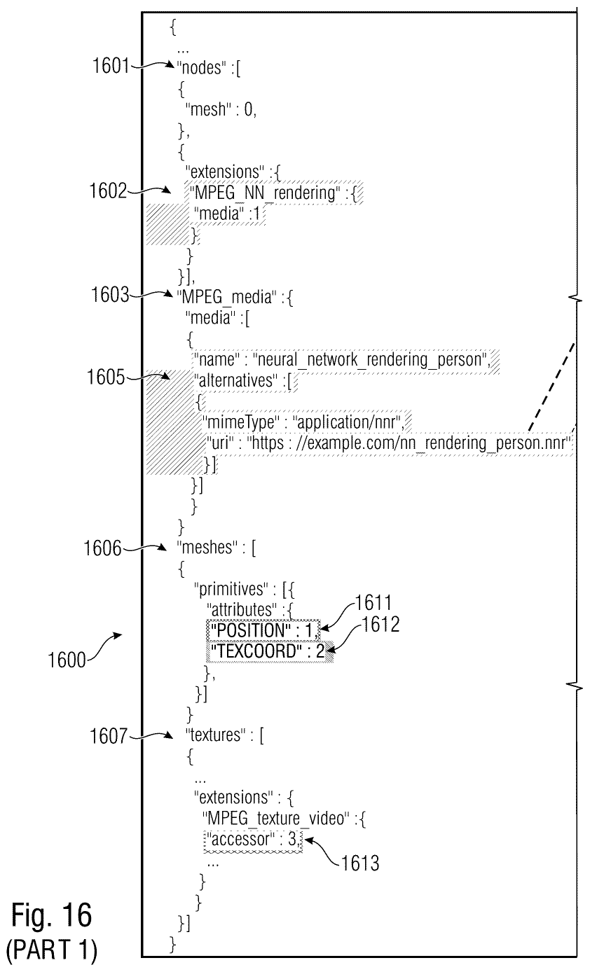

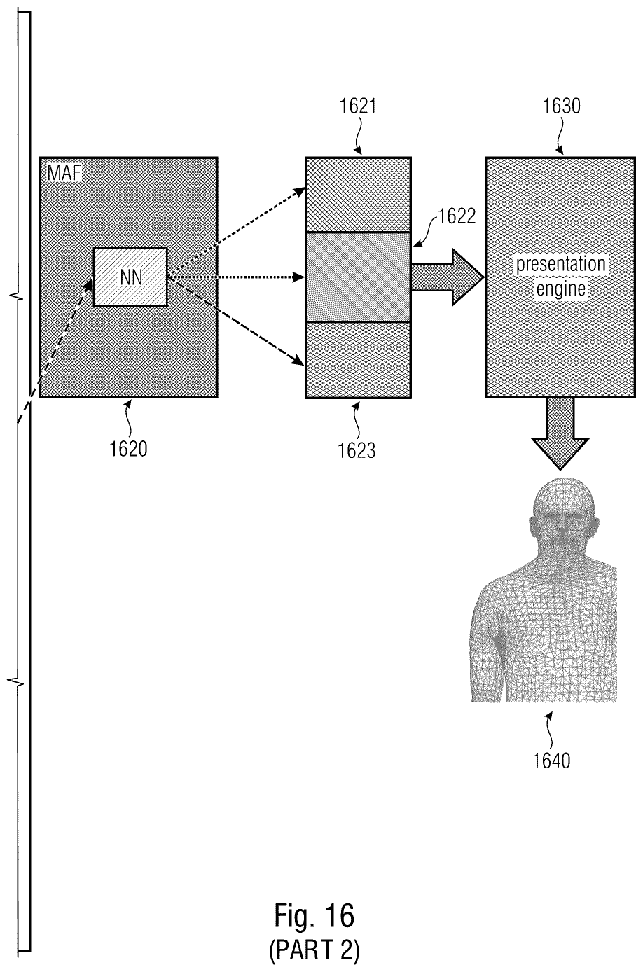

If the mesh were static, then the NN may, for example, be output into a buffer that follows a particular structure and, through accessors, each part (e.g., points, texture, texture coordinates) would, for example, be accessed. This is illustrated in FIG. 16.

FIG. 16 shows a schematic view of a use of a NN to generate mesh/texture based objects, according to embodiments. FIG. 16 shows an example of a code 1600 (e.g. as an example of a scene description information) for a scene description and its respective influence and/or interaction with a preprocessing unit 1620 in the form of an MAF (as an example), wherein as an optional feature, inference of the neural rendering is performed in the MAF, with accessors 1, 2, and 3 (e.g. indicating buffer sections) 1621, 1622, 1623 and a renderer 1630 in the form of a presentation engine (as an example) for the rendering of a human 1640 as an example of a second object. Elements 16xy of FIG. 16 may optionally correspond to elements 12xy in FIG. 12 and/or 13xy in FIG. 13 and/or 14xy in FIG. 14 and/or 15xy in FIG. 15, e.g. apart from the specific features of mesh information 1606 and texture information 1607.

In other words, FIG. 16 shows an example of a NN to generate mesh/texture based objects. In the example given above (e.g. as shown in FIG. 16), the mesh and texture objects of the glTF file described above point to a particular accessor (1 for position of the points, e.g. 1611, 2 for text coordinates, e.g. 1612, and 3 for the texture of the mesh, e.g. 1613) and this accessor (not shown in the example) point to a bufferView (e.g. a structure pointing to a part of a buffer) describing the position of the buffer at which each component is stored. This may, for example require the output of the NN to be in such a particular format so that the buffer is properly (e.g. in the right format) written.

Such additional information is beneficial or for example even needed within the scene description to split the output of the NN into the appropriate format (potentially requiring conversion) into the right media buffers as for instance shown in FIG. 15, e.g. example 4 with “output_structure”, e.g. 1510. The difference in this case would, for example, be that since it is known that the output corresponds to mesh, it may be clear that the outputs are the accessors pointed by POSITION, TEXCOORD and MPEG_texture_video or some predetermined attributes in a particular order.

In addition to the described components above, meshes may optionally have more components/attributes. For instance, vertex normals are often provided so that so-called smooth shading or Gouraud shading can be performed. This is mainly used for more realistic light reflection in the rendered scene, where the light direction and surface of the object are taken into account. Instead of using the normal of each face (e.g., triangle) to represent how light interacts with the polygon surface, an interpolation of the normal of the vertices of the face is applied to each point of the face, weighted based on the distance of that particular point to each of the vertices. Thus, a smoother and more realistic reflection effect is achieved and a “faceted look” of objects consisting of a finite amount of polygons is prevented.

Tangents also play an important role in rendering lightning and even though there are algorithms to calculate them (e.g., glTF recommends using default MikkTSpace algorithms to compute them when not available), they can be included into the glTF file as a further per vertex information.

This means that either the one NN as in the example above could also provide additional information per vertex, such as normal and tangents or further properties, or further additional NNs could be used for providing this information. Similar, association of the output of the NN to buffers could be performed for such characteristics (assuming they are stored as separate buffers) by information within the scene description document.

One aspect to further consider is if dynamic meshes change topology. The way that MPEG extensions deal with dynamic data is by defining circular buffer and timed accessors. The former simply defines buffer slots that can be used for storing each timed data (e.g., mesh points of a particular time-stamp), while the latter describes the underlaying data in the buffer (e.g., how many points are to be read from the buffer, i.e. how many points the mesh consists of). This means that the output of the NN when changing the topology, e.g., when changing the number of points that the output mesh consist of, requires properly modifying the value in the time accessor. In a further aspect of the embodiment the MAF may, for example, update the values of the time accessor, e.g. by parsing the output of the NN, e.g., checking how big the output mesh is. Alternatively, additional metadata may be provided together with the NN that conveys such information to the MAF so that the time accessors are properly updated, for example as required.

### 2) Point Cloud

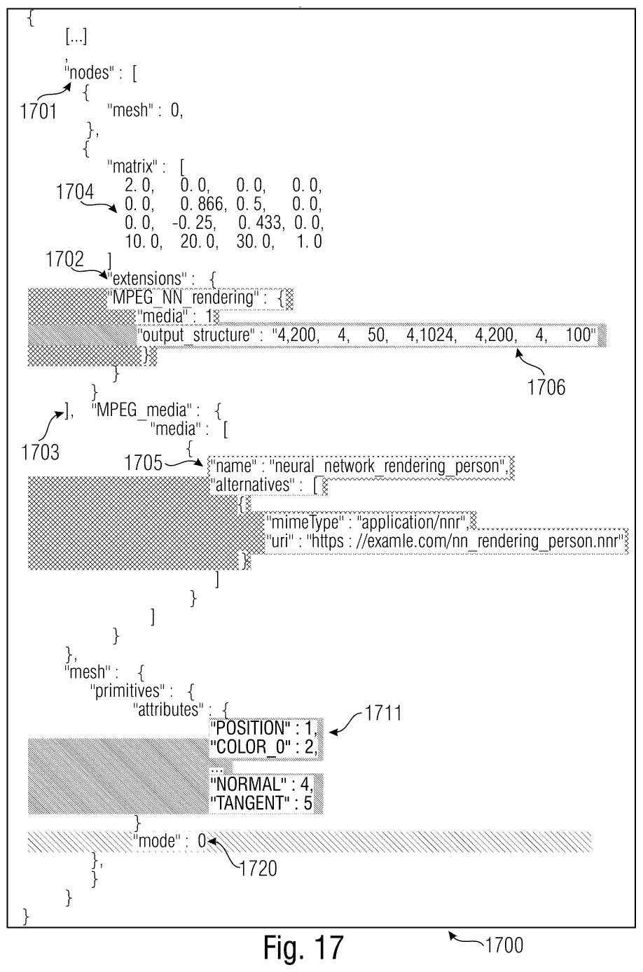

Another option according to embodiments is that the data output of the NN represents a point cloud. Note that the difference between meshes and point clouds is that points are not interconnected to define a surface with a texture as for polygon meshes. Therefore, points will be just points with some attributes, such as (one or more of a) colour, view-direction-dependent colour, transparency, opacity, density, etc. Still, same as for meshes, the NN (e.g. or more than one NN) may, for example, output the point cloud into a buffer, potentially with colour and additional attributes for each point/vertex (e.g. normal, tangets . . . ) and the presentation engine may, for example, be unaware of the existence of the NN rendering process. The following example in FIG. 17 shows the use of a point cloud (using the mesh attribute with mode 0, e.g. 1720,—POINTS—instead of mode 4—TRIANGLES) in the existing structure. FIG. 17 shows a fifth example (e.g. Example 5) of a code for a scene description according to embodiments. In particular, FIG. 17 shows an example of a glTF file (e.g. as an example of a scene description information 1700) with NN rendering attached to a node indicating that the output needs to be stored as a point cloud with 5 element and therefore 5 element pairs in “output_structure”, e.g. 1706. Elements 17xy of FIG. 17 may optionally correspond to elements 12xy in FIG. 12 and/or 13xy in FIG. 13 and/or 14xy in FIG. 14 and/or 15xy in FIG. 15 and/or 16xy in FIG. 16. As seen in the figure the output of the NN can, for example, be stored 5 accessors that describe the point cloud.

It is to be noted that in general, embodiments according to the invention may allow providing dynamic output formats, for example, dynamic meshes and/or point clouds. Hence, optionally, according to embodiments, the output format, defined by the neural output information, may be a dynamic mesh and/or a dynamic point cloud, the neural network information may, for example hence comprise an information about a size, e.g. a length information, e.g. “byteLength”, of the result of the inference and the preprocessing unit may be configured to update the information about the size of the result of the inference with respect to dynamic changes of the dynamic mesh and/or the dynamic point cloud.

In line with embodiments addressing dynamic outputs of the inference, it is to be noted that optionally, the one or more buffers may be circular buffers and the first and/or second object may be a dynamic object wherein the rendering information may be a timed rendering information and the preprocessing unit, e.g. MAF, may be configured to provide, based on the timed rendering information, a timed rendering input to the one or more buffers and the one or more buffers may be configured to provide the timed rendering input to the renderer. Alternatively or in addition, the neural input information may, for example, be a timed neural input information and the pre-processing unit may be configured to provide, based the timed neural input information, a timed neural input to the one or more buffers and the one or more buffers may be configured to provide the timed neural input to the renderer.

### 3) 2d Image

Rendering a 2d image in a 3d environment can be seen as a specific case of mesh/texture rendering. In this scenario, the mesh may, for example, simply be a plane and the texture may, for example, directly correspond to the 2d image.

The information required in order to render a plane in a 3d scene can be greatly simplified compared to the rendering of traditional complex meshes. A basic setup may, for example comprise and/or require only the following attributes:
3d position of the four corners of the plane (it can, for example, be substituted for just one position, i.e. the bottom left corner, length and width)
Direction of the plane
Information of the texture.

The texture of the plane (and, for example, its orientation) could optionally as well be modified over time. This could allow, for example, to represent an object that seems 3d, by providing rendered textures from different angles, while the actual information is only bidimensional.

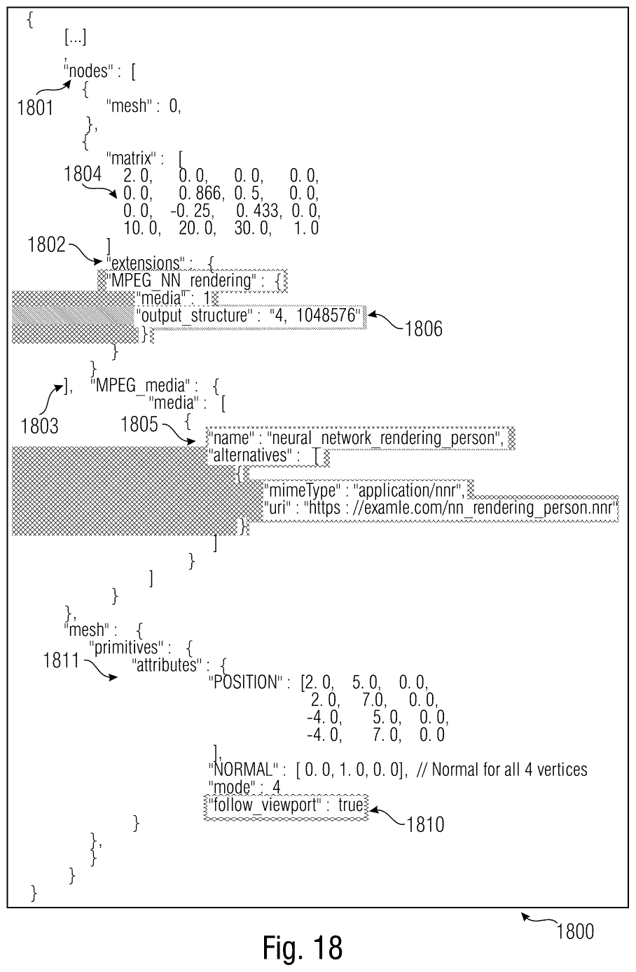

Reference is made to FIG. 18, showing a sixth example (e.g. Example 6) of a code for a scene description according to embodiments. In particular, FIG. 18 shows an example of a glTF file (e.g. as an example of a scene description information 1800) with NN rendering attached to a node indicating that the output needs to be stored as a 2D video and therefore 1 element pairs in “output_structure”. Elements 18xy of FIG. 18 may optionally correspond to elements 12xy in FIG. 12 and/or 13xy in FIG. 13 and/or 14xy in FIG. 14 and/or 15xy in FIG. 15 and/or 16xy in FIGS. 16 and/or 17xy in FIG. 17.

As a further aspect of this embodiment the direction of the plane could be indicated to follow the viewpoint of the user (e.g. adding an attribute follow_viewport, e.g. 1810), without directly indicating each time the direction changes by means of coordinates or normal of the plane within the glTF document.

Hence, in general, the neural network information optionally comprises an information about a viewport; and the renderer may be configured to provide a rendition of an object, e.g. the object 503a, or the second object 504b in the form of a 2d image based on the information about the viewport.

As an example, the neural network information may, for example only, indicate that the viewpoint/viewport needs to be followed. As a result, typically the viewpoint/viewport may be taken into account during NN rendering.

In particular, optionally, the information about the viewport may indicate a change of a point of view of a viewer of the scene over time; and the renderer may be configured to update the rendition of the object or the second object in the form of a 2d image based on an information about the change of the point of view.

In other words, a resulting 2D video may follow a viewport of a user, i.e. is always related to an eye-buffer, the eye-buffer, for example, representing a 2D image plane, which is provided to a viewer, e.g. for usage with VR goggles.

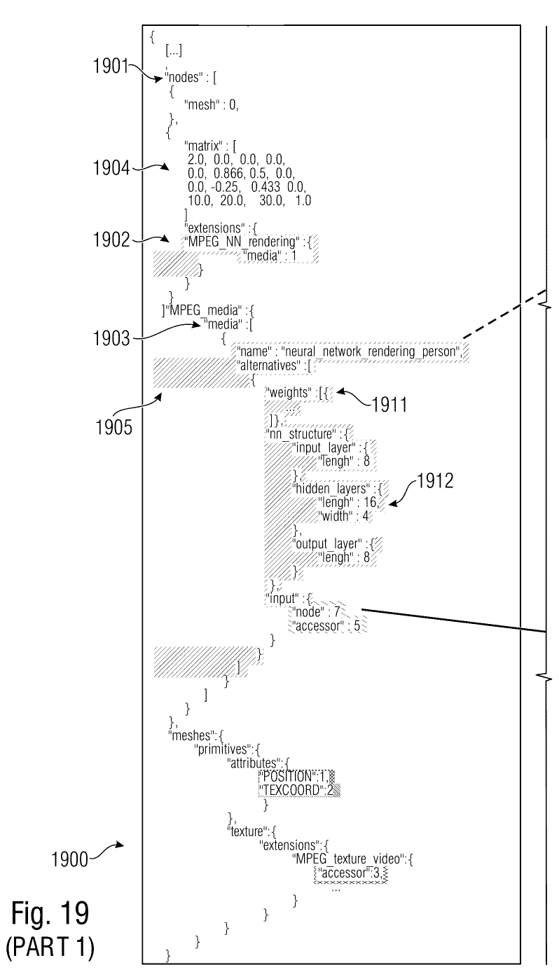

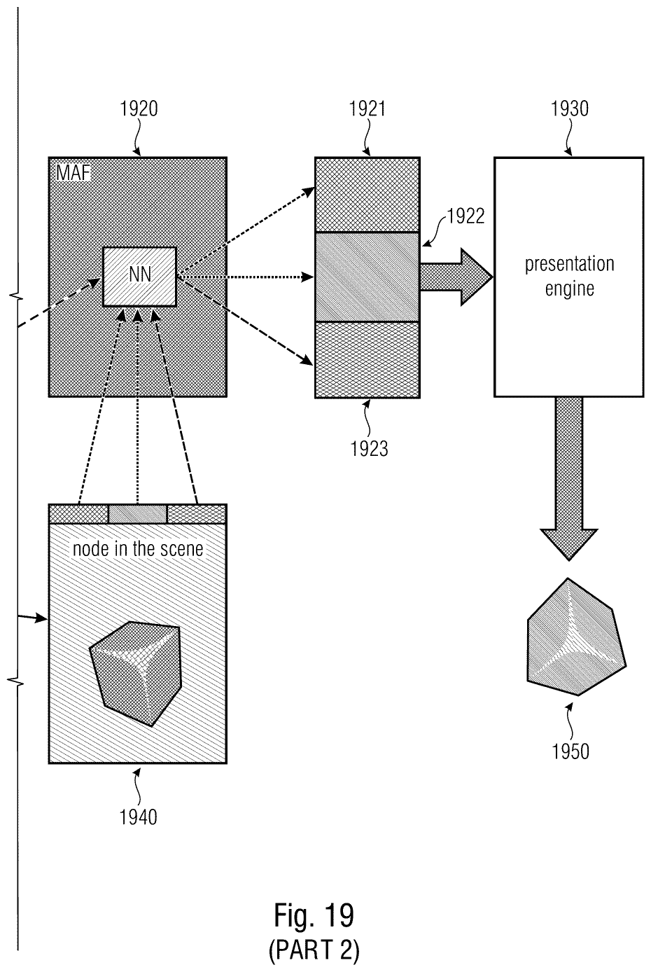

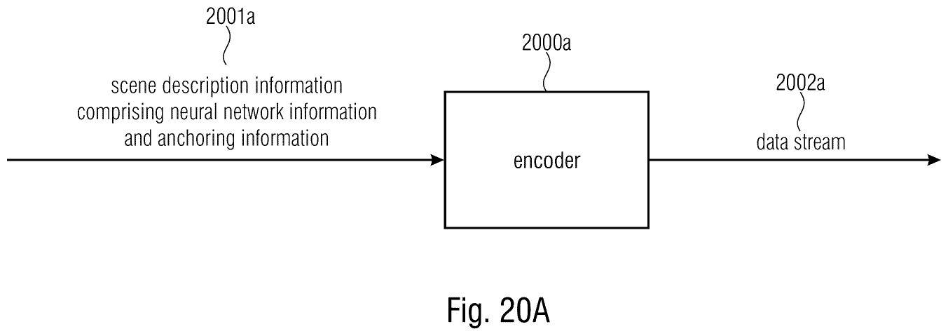

A further option regarding the multiple type of inputs that are envisioned for such applications is discussed in the following. Since the input of the NN can be, in principle, any kind of data that allows or for example even guarantees a correct representation in one of the formats mentioned above (e.g. mesh, point cloud and/or 2d image), the possibility of using already existing objects in the scene as an input may, be or for example must be contemplated. In this case, the NN may, for example, be used to modify or update existing objects of the scene, parts of these objects or specific characteristics (only the texture, only the points of a certain region, e.g. re-illumination as described in FIG. 8 d), etc.). An example of this can be seen in FIG. 19.

FIG. 19 shows an example of a code 1900 (e.g. as an example of a scene description information) for a scene description and its respective influence and/or interaction with a preprocessing unit 1920 in the form of an MAF (as an example), wherein as an optional feature,

inference of the neural rendering is performed in the MAF, accessors 1, 2, and 3 (e.g. indicating buffer sections) 1921, 1922, 1923 and a renderer 1930 in the form of a presentation engine (as an example) for a manipulation of an object 1940 associated with a node in order to render a manipulated version 1950 of said object. In other words, FIG. 19 shows a schematic view of an example for the use of NNs to modify existing objects of the scene.

Two different approaches can be considered (according to embodiments) here.

The first one is a modification or enhancement of a particular object in a particular form that can be represented with existing rendering APIs. For instance, the texture of a mesh could be enhanced and further lighting/reflections could be added on top by the NN to a modified mesh. A point cloud could be super-sampled by an NN taking the original point-cloud and some additional input into a much more dense point cloud. An image could be enhanced by an NN adding some depth information; higher resolution, different colour space... On any of these examples the most straight-forward approach would be to include the extension as part of different attributes like meshes, textures, nodes while directly substituting their content by a different one in the same format, e.g. mesh-to-mesh, point cloud-to-point cloud, image-to-image.

Also, it could perform even a change of format, e.g. point cloud-to-mesh; image-to-mesh, etc. Similarly, the output would require to be described and this information should be provided in glTF in a similar manner as described above. FIG. 19 shows the example where buffers/accessors are used for the association of output of the NN and glTF structures. Elements 1901 to 1904 of FIG. 19 may optionally correspond to elements 1201 to 1204 in FIG. 12 and/or 1301 to 1304 in FIG. 13 and/or 1401 to 1404 in FIG. 14 and/or 1501 to 1504 in FIG. 15 and/or 1601 to 1604 in FIG. 16 and/or 1701 to 1704 in FIG. 17.

In line with FIG. 19, it is to be noted that according to embodiments, in general, the neural network information optionally comprises an information about neural network parameters and/or an information about a neural network topology for the neural rendering. Such an information may, for example be the respective weights, e.g. 1911, and/or layer or respectively structural information, e.g. 1912.

However, it is to be noted that in general, optionally, the neural network information may comprise, for example only, a referencing information, e.g. an uri; e.g. an URL, e.g. for downloading a binary executable comprising an information about neural network parameters and/or an information about a neural network topology, which indicates a source from which the information about the neural network parameters and/or about the neural network topology for the neural rendering can be retrieved. Examples therefore are shown in the above discussed FIGS. 18, 17, 16, 15, 14, 13 and 12, wherein the information about a respective neural network is indicated may an uri.

Furthermore, referring to the above explanations regarding output formats in the form of Mesh and textures, point clouds and 2d images it is to be noted that accordingly, as an optional feature, the output format, defined by the neural output information, may be a mesh, wherein the result of the inference comprises a plurality of mesh attributes, and wherein the mesh attributes comprise an information about a plurality of vertices of the mesh, an information about one or more textures, and an information about texture coordinates.

Alternatively or in addition, the output format, defined by the neural output information, may be a point cloud, wherein the result of the inference comprises a plurality of point cloud attributes, and wherein the point cloud attributes comprise at least one of an information about a plurality of points, an information about point normals, an information about point tangents, an information about a color, an information about a view-direction-dependent color, an information about a transparency, an information about a opacity, and an information about a density.

Alternatively or in addition, the output format, defined by the neural output information, is a 2d image, e.g. as a special case of a mesh, wherein the result of the inference comprises a plurality of 2d image attributes, and wherein the 2d image attributes comprise an information about a position of the 2d image in the scene, a direction of an image plane of the 2d image in the scene and an information about a texture of the 2d image.

Furthermore, optionally, the neural network information comprises an information about a plurality of different buffers and/or an information about a plurality of different subsections, e.g. bufferViews, of buffers, e.g. in the form of assessors, in which a respective different mesh attribute, a respective different point cloud attribute and/or a respective different 2d image attribute is to be stored. In addition, optionally, the preprocessing unit, e.g. MAF, is configured to store a respective different mesh attribute, a respective different point cloud attribute and/or a respective different 2d image attribute in accordance with the neural network information in different buffers and/or in different subsections of buffers; and the decoder may hence be configured to provide the neural network information to the renderer, in order for the renderer to obtain the result of the inference from the respective buffer or respective subsection of a buffer.

Furthermore, as shown in the context of FIG. 12 to 19, as an optional feature, the preprocessing unit, e.g. MAF, may be configured to store the result of the inference in the one or more buffers; and the neural network information optionally comprises an information about at least one of the following: an ID information (e.g. an information about an accessor, the accessor for example pointing to a bufferView, e.g. a part of a buffer; e.g. an integer value, e.g. an index value, e.g. ““buffer”) of the one or more buffers for the storing of the result of the inference, an

information (e.g. an information about an accessor, the accessor for example pointing to a bufferView, e.g. a part of a buffer; e.g. an offset value within a buffer; e.g. de-fining a bufferView, e.g. “byteOffset”) about a subsection of, and/or about a position within, a respective buffer of the one or more buffers for the storing of the result of the inference, an information about a size (e.g. a length information, e.g. “byteLength”) of the result of the inference in a respective buffer and/or in a respective subsection of a buffer; and an information about a format (e.g. about a structure, e.g. “output_structure”) of the result of the inference in a respective buffer and/or in a respective subsection of a buffer.

Referring again to FIG. 19, in general, optionally, the neural input may comprise, or, for example, represent, at least one of a mesh, a point cloud and/or a 2d image; and the preprocessing unit may be configured to obtain a modified mesh, a modified point cloud and/or a modified 2d image as a result of the inference. Alternatively, the preprocessing unit may be configured provide the neural input via one or more buffers to a renderer in order to obtain a modified mesh, a modified point cloud and/or a modified 2d image as a result of the neural rendering

### 3. Integration of NN Based Rendering

As already mentioned, according to embodiments, rendering could directly happen without any intermediate step of converting the output of the NN into a mesh or a point cloud (e.g. in line with the embodiments shown in FIG. 7). As such, the integration of this new rendering paradigm may, for example comprise or even require some extensions. The embodiments described below, even though being motivated in the context of NeRF, apply generically to any NN rendering mechanism that performs rendering without an explicit 3D representation. This can, for example, be included in a scene where elements represented in different formats, such as the ones mentioned above (e.g. meshes, point clouds), are already present. Hence, embodiments are not limited to NeRF.

Since NeRF is able to provide novel views of an object/scene by modifying the input position and view direction, it can be possible to add the output of the NN to the scene through the use of a simple mesh consisting of a single plane, as already explained in the previous section. However, in this option described here it would be obvious that the NN rendering engine would directly render the image corresponding to the viewport. The 2d image provided by the NN will be used as the texture of the object, and this can be updated over time. This can be used as an advantage when rendering the object. The viewing position is used to render the proper texture and the object itself does not need to include specific orientation information.

Further, it should be considered that in some cases the rendered viewport by NN may comprise or may, for example even need a final step to combine the rendered view with other objects rendered potentially by other NNs or traditional rendering mechanisms. Additional information can, optionally, be included in the scene description document that may indicate or that would be to indicate that the sample values rendered by the NN within the viewport of the user are to be, or may even need to be superposed with other objects within the scene that are not rendered by the NN. The signaling within the glTF document could be simply indicated by a mode meaning NN_rendering and/or could have further information such as depth or transparency or the like to be able to perform the combined rendering of the scene. This latter information could either be part of the output of the NN or be additional information that is directly provided as attributes of the extension NN_rendering.

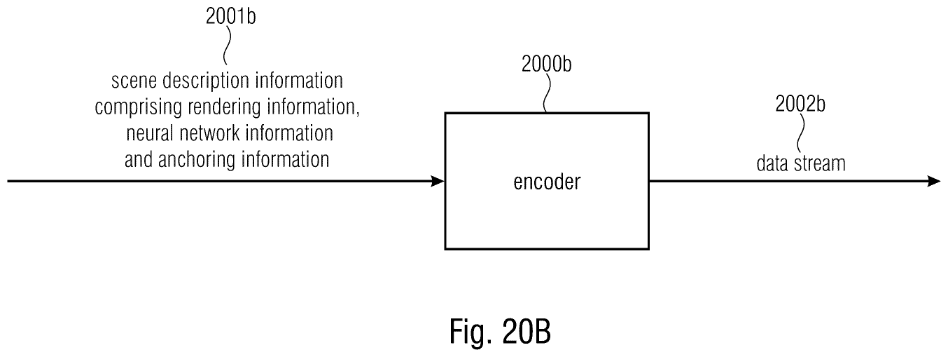

Next, reference is made to FIG. 20a, b showing schematic views of encoders according to embodiments of the invention.

FIG. 20a shows an encoder 2000a, wherein the encoder 2000a is configured to encode, into a data stream 2002a, a scene description information 2001a (e.g. corresponding to scene description information 401′, 601′, 701′, 1200-1900) for a rendering of a scene, which comprises a neural network information for a neural rendering of an object of the scene, and an anchoring information, which indicates a position of the object within the scene.

FIG. 20b shows an encoder 2000b, wherein the encoder 2000b is configured to encode, into a data stream 2002b, a scene description information 2001b (e.g. corresponding to scene description information 401′, 601′, 701′, 1200-1900) for a rendering of a scene, which comprises a rendering information for a rendering of a first object of a scene, the first object having a first position within the scene, a neural network information for a neural rendering of a second object of the scene, and an anchoring information, which indicates a second position of the second object within the scene.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

The inventive encoded audio and/or video signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] NeRF: Representing Scenes as Neural Radiance Fields for View Synthesis (https://arxiv.org/pdf/2003.08934.pdf)
[2] D-NeRF: Neural Radiance Fields for Dynamic Scenes (https://arxiv.org/pdf/2011.13961.pdf)
[3] Instant Neural Graphics Primitives with a Multiresolution Hash Encoding (https://nvlabs.github.io/instant-ngp/assets/mueller2022instant.pdf)

1. A decoder,
wherein the decoder is configured to decode, from a data stream, a scene description information for a rendering of a scene, which comprises:
a neural network information for a neural rendering of an object of the scene, and
an anchoring information, which indicates a position of the object within the scene.

2. A decoder,
wherein the decoder is configured to decode, from a data stream, a scene description information for a rendering of a scene, which comprises:
a rendering information for a rendering of a first object of the scene, the first object having a first position within the scene,
a neural network information for a neural rendering of a second object of the scene, and
an anchoring information, which indicates a second position of the second object within the scene.

3. The decoder according to claim 1,
wherein the scene description information further comprises:
an additional neural network information for a neural rendering of an additional object of the scene, and
an additional anchoring information, which indicates a position of the additional object within the scene.

4. The decoder according to claim 2,
wherein the rendering information for the first object comprises an information about a mesh and/or about a point cloud of a representation of the first object.

5. The decoder according to claim 1,
wherein the neural network information comprises an information about neural network parameters and/or an information about a neural network topology for the neural rendering.

6. The decoder according to claim 1,
wherein the neural network information comprises a referencing information, which indicates a source from which the information about the neural network parameters and/or about the neural network topology for the neural rendering can be retrieved.

7. The decoder according to claim 1,
wherein the object, and/or the first and/or second object is a dynamic object.

8. The decoder according to claim 1,
wherein the scene description information comprises a representation of the scene;
wherein the representation of the scene is structured as a hierarchical tree structure comprising a plurality of scene elements;
wherein the scene is represented by the plurality of scene elements of the hierarchical tree structure;
wherein the neural network information is an extension of a scene element; and
wherein the anchoring information represents a position information of this scene element.

9. The decoder according to claim 1,
wherein the scene description information comprises a representation of the scene;
wherein the representation of the scene is structured as a hierarchical tree structure comprising a plurality of scene elements;
wherein the scene is represented by the plurality of scene elements of the hierarchical tree structure;
wherein the neural network information represents an individual scene element of the of the hierarchical tree structure of the scene; and
wherein the anchoring information represents a position information of this individual scene element.

10. A system comprising a decoder according to claim 1 and a preprocessing unit;
wherein the neural network information comprises a neural input information indicating a neural input;
wherein the decoder is configured to provide the neural input information to the preprocessing unit, which is configured to obtain the neural input, which is indicated by the neural input information, and to provide a version of said neural input via one or more buffers to a renderer for performing the inference for the neural rendering based on the version of the neural input; and
wherein the decoder is configured to provide the scene description information, at least partially, to the renderer.

11. The system according to claim 10,
wherein the preprocessing unit is configured to convert the neural input, which is indicated by the neural input information, from a delivery format to a rendering format, in order to obtain a version of the neural input and to provide the version of the neural input, via the one or more buffers to the renderer.

12. The system according to claim 10, further comprising the renderer;
wherein the decoder is configured to provide the rendering information to the preprocessing unit, which is configured to derive, from the rendering information, a rendering input in the form of a mesh, a 2D video/audio and/or a point cloud, and to provide a version of said rendering input, via the one or more buffers, to the renderer; and
wherein the renderer is configured to perform a mixed rendering of the scene including a rendition of the first object based on the version of the rendering input and a neural rendition of the second object based on the version of the neural input, the neural network information and the anchoring information.

13. The system according to claim 10 further comprising the renderer,
wherein the renderer is configured to perform a mixed rendering of the scene, so that a result of the neural rendering of the second object is a 2d image, of which a position in the rendered scene is set in accord with the anchoring information; and/or
wherein the renderer is configured to perform a rendering of the scene, so that a result of the neural rendering of the object is a 2d image of which a position in the rendered scene is set in accord with the anchoring information.

14. The system according to claim 10,
wherein the scene description information comprises an indication that a mixed rendering is to be performed;
wherein the decoder is configured to provide the indication to the renderer; and
wherein the renderer is configured to, based on the indication, combine the renderings of the first and second object of the scene in a superposed manner.

15. The system according to claim 10 further comprising the renderer,
wherein the neural network information comprises an information about a viewport; and
wherein the renderer is configured to provide a rendition of the object or the second object in the form of a 2d image based on the information about the viewport.

16. The system according to claim 15,
wherein the information about the viewport indicates a change of a point of view of a viewer of the scene over time; and
wherein the renderer is configured to update the rendition of the object or the second object in the form of a 2d image based on an information about the change of the point of view; and/or
wherein a point of view of a viewer of the scene, for which the scene is to be rendered, changes over time; and
wherein the renderer is configured to update the rendition of the object or the second object in the form of a 2d image with respect to the change of the point of view.

17. A system comprising a decoder according to claim 1 and a preprocessing unit;
wherein the decoder is configured to provide the neural network information to the preprocessing unit;
wherein the preprocessing unit is configured to perform an inference for the neural rendering based on the neural network information and a neural input.

18. The system according to claim 17,
wherein the neural network information comprises a neural input information indicating the neural input based on which the inference is to be performed for the neural rendering.

19. The system according to claim 17,
wherein the neural network information comprises a neural output information defining a format of an output of the neural rendering;
wherein the preprocessing unit is configured to provide a result of the inference in the format as defined by the neural output information via one or more buffers to a renderer.

20. The system according to claim 19,
wherein the neural output information defines the output of the neural rendering to be at least one of
a mesh, a point-cloud, a 2D image, an animated 2D image, an animated mesh, an illuminated mesh, an illuminated 2D image an opacity dependent color and a viewing direction dependent color.

21. The system according to claim 19, further comprising the renderer;
wherein the decoder is configured to provide the rendering information to the preprocessing unit, which is configured to derive, from the rendering information, a rendering input in the form of a mesh and/or a point cloud, and which is configured to provide an information about said rendering input via the one or more buffers to the renderer;
wherein the preprocessing unit is configured to provide an information about the result of the inference in the form of a mesh and/or a point cloud via the one or more buffers to the renderer;
wherein the preprocessing unit and/or the renderer is configured to use the anchoring information in order to place the second object at the second position within the scene; and
wherein the renderer is configured to perform a rendering of the scene, including a rendition of the first object based on the information about the rendering input in the form of a mesh and/or a point cloud and a rendition of the second object based on the information about the result of the inference in the form of the mesh and/or the point cloud.

22. The system according to claim 19,
wherein the output format, defined by the neural output information, comprises a plurality of different output attributes;
wherein the neural network information comprises an information about a plurality of different buffers and/or an information about a plurality of different subsections of buffers in which a respective different attribute is to be stored;
wherein the preprocessing unit is configured to store a respective different attribute in accordance with the neural network information in different buffers and/or in different subsections of buffers; and
wherein the decoder is configured to provide the neural network information to the renderer, in order for the renderer to obtain the result of the inference from the respective buffer or respective subsection of a buffer.

23. The system according to claim 19,
wherein the output format, defined by the neural output information, is a mesh, wherein the result of the inference comprises a plurality of mesh attributes, and wherein the mesh attributes comprise an information about a plurality of vertices of the mesh, an information about one or more textures, and an information about texture coordinates; and/or
wherein the output format, defined by the neural output information, is a point cloud, wherein the result of the inference comprises a plurality of point cloud attributes, and wherein the point cloud attributes comprise at least one of an information about a plurality of points, an information about point normals, an information about point tangents, an information about a color, an information about a view-direction-dependent color, an information about a transparency, an information about a opacity, and an information about a density; and/or
wherein the output format, defined by the neural output information, is a 2d image, wherein the result of the inference comprises a plurality of 2d image attributes, and wherein the 2d image attributes comprise an information about a position of the 2d image in the scene, a direction of an image plane of the 2d image in the scene and an information about a texture of the 2d image; and
wherein the neural network information comprises an information about a plurality of different buffers and/or an information about a plurality of different subsections of buffers in which a respective different mesh attribute, a respective different point cloud attribute and/or a respective different 2d image attribute is to be stored;
wherein the preprocessing unit is configured to store a respective different mesh attribute, a respective different point cloud attribute and/or a respective different 2d image attribute in accordance with the neural network information in different buffers and/or in different subsections of buffers; and
wherein the decoder is configured to provide the neural network information to the renderer, in order for the renderer to obtain the result of the inference from the respective buffer or respective subsection of a buffer.

24. The system according to claim 19,
wherein the output format, defined by the neural output information, is a dynamic mesh and/or a dynamic point cloud;
wherein the neural network information comprises an information about a size of the result of the inference; and
wherein the preprocessing unit is configured to update the information about the size of the result of the inference with respect to dynamic changes of the dynamic mesh and/or the dynamic point cloud.

25. The system according to claim 17,
wherein the preprocessing unit is configured to store the result of the inference in the one or more buffers; and
wherein the neural network information comprises an information about at least one of the following:
an ID information of the one or more buffers for the storing of the result of the inference,
an information about a subsection of, and/or about a position within, a respective buffer of the one or more buffers for the storing of the result of the inference,
an information about a size of the result of the inference in a respective buffer and/or in a respective subsection of a buffer; and
an information about a format of the result of the inference in a respective buffer and/or in a respective subsection of a buffer.

26. The system according to claim 10,
wherein the neural input information comprises at least one of an index and/or ID to a buffer comprising a media data, and an index and/or ID to a media stream; and/or
wherein the neural input comprises at least one of
a viewpoint information, an audio information, a text information, a mesh, a point-cloud; a 2D video, and lighting parameters.

27. The system according to claim 10,
wherein the neural input information comprises an information about an amount of inputs that are to be considered for the determination of the neural input.

28. The system according to claim 10, further comprising the one or more buffers;
wherein the one or more buffers are circular buffers;
wherein the first and/or second object is a dynamic object;
wherein the rendering information is a timed rendering information and the preprocessing unit is configured to provide, based on the timed rendering information, a timed rendering input to the one or more buffers and the one or more buffers are configured to provide the timed rendering input to the renderer; and/or
wherein the neural input information is a timed neural input information and the preprocessing unit is configured to provide, based the timed neural input information, a timed neural input to the one or more buffers and the one or more buffers are configured to provide the timed neural input to the renderer.

29. The system according to claim 10;
wherein the neural input comprises at least one of a mesh, a point cloud and/or a 2d image; and
wherein the preprocessing unit is configured to obtain a modified mesh, a modified point cloud and/or a modified 2d image as a result of the inference; or
wherein the preprocessing unit is configured provide the neural input via one or more buffers to a renderer in order to obtain a modified mesh, a modified point cloud and/or a modified 2d image as a result of the neural rendering.

30. An encoder,
wherein the encoder is configured to encode, into a data stream, a scene description information for a rendering of a scene, which comprises
a rendering information for a rendering of a first object of a scene, the first object having a first position within the scene,
a neural network information for a neural rendering of a second object of the scene, and
an anchoring information, which indicates a second position of the second object within the scene.

31. A method comprising:
decoding, from a data stream, a scene description information for a rendering of a scene, which comprises
a rendering information for a rendering of a first object of a scene, the first object having a first position within the scene,
a neural network information for a neural rendering of a second object of the scene, and
an anchoring information, which indicates a second position of the second object within the scene.

32. A method comprising:
encoding, into a data stream, a scene description information for a rendering of a scene, which comprises
a rendering information for a rendering of a first object of a scene, the first object having a first position within the scene,
a neural network information for a neural rendering of a second object of the scene, and
an anchoring information, which indicates a second position of the second object within the scene.

33. A computer program for performing the method according to claim 31 when the computer program runs on a computer.

34. A data stream comprising:
a scene description information for a rendering of a scene, which comprises
a rendering information for a rendering of a first object of a scene, the first object having a first position within the scene,
a neural network information for a neural rendering of a second object of the scene, and
an anchoring information, which indicates a second position of the second object within the scene.

35. An encoder,
wherein the encoder is configured to encode, into a data stream, a scene description information for a rendering of a scene, which comprises
a neural network information for a neural rendering of an object of the scene, and
an anchoring information, which indicates a position of the object within the scene.

36. A method comprising:
decoding, from a data stream, a scene description information for a rendering of a scene, which comprises
a neural network information for a neural rendering of an object of the scene, and
an anchoring information, which indicates a position of the object within the scene.

37. A method comprising:
encoding, into a data stream, a scene description information for a rendering of a scene, which comprises
a neural network information for a neural rendering of an object of the scene, and
an anchoring information, which indicates a position of the object within the scene.

38. Data stream comprising:
a scene description information for a rendering of a scene, which comprises
a neural network information for a neural rendering of an object of the scene, and
an anchoring information, which indicates a position of the object within the scene.
